(19) United States
(12) Patent Application Publication
(10) Pub. No.: US 2017/0249730 A1
(43) Pub. Date: Aug. 31, 2017

(54) METHODS, APPARATUS, SYSTEMS AND MEDIA FOR USE IN ASSOCIATION WITH SUBSEA EQUIPMENT LOCATED IN A TOPSIDE ENVIRONMENT

(71) Applicant: General Electric Company, Schenectady, NY (US)

(72) Inventors: Paulo Gallotti RODRIGUES, Rio de Janeiro (BR); Marcelo Blois RIBEIRO, Rio de Janeiro (BR); Isela BERTRAN, Rio de Janeiro (BR); Leonardo ORENSTEIN, Rio de Janeiro (BR); Newton Brito JUNIOR, Macae (BR); Mario MELO, Macae (BR); Rodrigo MAIA, Macae (BR); Camila NUNES, Rio de Janeiro (BR); Carla WANDERLEY, Rio de Janeiro (BR)

(21) Appl. No.: 15/053,777

(22) Filed: Feb. 25, 2016

(51) Int. Cl. G06T 7/00; H04N 5/232; E21B 47/00

(52) U.S. Cl. CPC G06T 7/0004; E21B 47/0002; H04N 5/23293; G06T 2207/30232

(57) ABSTRACT

In one aspect, apparatus comprises: a mobile device having an image sensor to generate an image of subsea equipment that is located in a topside environment; and a mobile device having a display to display a view that includes: (i) a representation of the subsea equipment that is located in a topside environment and (ii) an indicator that indicates a portion of the representation that includes a representation of one or more portions of the subsea equipment that are to be inspected while the subsea equipment is located in a topside environment.

### FIELD

Embodiments of the present disclosure relate generally to methods, apparatus, systems and media for use in association with subsea equipment that is located in a topside environment.

### BACKGROUND

Subsea equipment is found in many industries including, but not limited to, offshore oil and gas industries, underwater mining, underwater geology, offshore wind power industries, and marine biology. Such equipment is often installed and/or operated at depths of tens, hundreds and/or thousands of feet beneath the surface of a sea and/or other aquatic body.

Subsea equipment is often inspected for damage and/or proper operation while located in a topside environment (on a ship, on a platform and/or some other topside environment), prior to installing and/or operating the subsea equipment beneath the surface of the sea and/or other aquatic body.

The inspection process is traditionally performed by one or more field service engineers and it is a time consuming process. Field service engineers often use a lengthy service manual that consists in large part of two dimensional diagrams and technical drawings, procedures and tools from which the engineers abstract information. This information is used for different purposes, such as field service engineers use to locate and inspect one or more portions of the subsea equipment. In addition to performing the actual inspection, the field service engineers often create a record of the procedures that they use and the findings that they make.

### BRIEF DESCRIPTION

It has been determined that it is possible to assist a field service engineer (and/or other person), in one or more respects, in regard to inspecting (and/or other activity associated with) subsea equipment located in a topside environment.

In a first aspect, apparatus comprises a mobile device having an image sensor to capture an image of subsea equipment that is located in a topside environment. The apparatus further comprises a mobile device having a display to display a view that includes: (i) a representation of the subsea equipment and (ii) an indicator that indicates a portion of the representation that includes a representation of one or more portions of the subsea equipment that are to be inspected.

As such, in some embodiments, the apparatus may help a field service engineer (and/or another person) perform faster and/or more accurate inspections.

In some embodiments, the apparatus may reduce the need for the field service engineer (and/or another person) to abstract information from two dimensional diagrams and technical drawings in the lengthy service manuals that are often used in order to locate the one or more portions of the subsea equipment (which unlike the two dimensional drawings, is a three dimensional object) that are to be inspected while the subsea equipment is located in a topside environment, and thereby reduces the level of abstraction that is needed on the part of a field service engineer (and/or another person) in order to locate the one or more portions of the subsea equipment that are to be inspected while the subsea equipment is located in a topside environment.

In some embodiments, the indicator draws attention to a portion of the representation that includes a representation of one or more portions of the subsea equipment that are to be inspected while the subsea equipment is located in a topside environment.

In some embodiments, the apparatus further comprises a processor to: determine, based at least in part on the image of the subsea equipment that is located in a topside environment, one or more of the one or more portions of the subsea equipment that are to be inspected; and determine, based at least in part on the image of the subsea equipment that is located in a topside environment, the representation of the subsea equipment.

In some embodiments, the processor is further operated to: receive a request from a user to modify a characteristic of the representation of the subsea equipment that is located in a topside environment; and determine a second representation of the subsea equipment based at least in part on the request from a user to modify a characteristic of the representation; and wherein the display is further to display a second view that includes: (i) the second representation of the subsea equipment and (ii) an indicator that indicates a portion of the second representation that includes a representation of one or more portions of the subsea equipment that are to be inspected.

In some embodiments, the image sensor is further to generate a second image of subsea equipment that is located in a topside environment; the processor is further operated to determine a second representation of the subsea equipment based at least in part on the second image of the subsea equipment; and the display is further configured to display a second view that includes: (i) the second representation of the subsea equipment and (ii) an indicator that indicates a portion of the second representation that includes a representation of one or more portions of the subsea equipment that are to be inspected.

In some embodiments, the processor is further configured to receive a request from a user for instructions in regard to performing an inspection of one or more of the one or more portions of the subsea equipment.

In some embodiments, the processor is further configured to receive a result of an inspection of one or more of the one or more portions of the subsea equipment that are to be inspected.

In a second aspect, a method comprises: generating, by an image sensor of a mobile device, an image of subsea equipment that is located in a topside environment; and displaying, by a display of a mobile device, a view that includes: (i) a representation of the subsea equipment and (ii) an indicator that indicates a portion of the representation that includes a representation of one or more portions of the subsea equipment that are to be inspected.

In a third aspect, a non-transitory computer readable storage medium having code stored thereon, the code being executable by a processor to result in a method comprising: generating, by an image sensor of a mobile device, an image of subsea equipment that is located in a topside environment; and displaying, by a display of a mobile device, a view that includes: (i) a representation of the subsea equipment and (ii) an indicator that indicates a portion of the representation that includes a representation of one or more portions of the subsea equipment.

In a fourth aspect, apparatus comprises: a mobile device having an image sensor to generate an image of subsea equipment that is located in a topside environment; at least one processor to determine, based at least in part on the image of the subsea equipment that is located in a topside environment, one or more portions of the subsea equipment that are to be inspected while the subsea equipment is located in a topside environment; and a mobile device having a display to display a view that includes: (i) a representation of the subsea equipment and (ii) an indicator that indicates a portion of the representation that includes a representation of one or more of the one or more portions of the subsea equipment that are to be inspected.

In a fifth aspect, a mobile device comprises: an image sensor to generate an image of subsea equipment that is located in a topside environment; at least one processor to determine, based at least in part on the image of the subsea equipment that is located in a topside environment, one or more portions of the subsea equipment that are to be inspected; a memory, coupled to the processor and storing code executable by the processor; and a display to display a view that includes: (i) a representation of the subsea equipment and (ii) an indicator that indicates a portion of the representation that includes a representation of one or more of the one or more portions of the subsea equipment that are to be inspected.

### BRIEF DESCRIPTION OF THE DRAWINGS

FIG. 1 is a diagram of a system, in accordance with some embodiments.

FIG. 2 is a flow chart of a prior art method.

FIGS. 3A-3C are a flow chart of a method, in accordance with some embodiments.

FIGS. 4A-4B are perspective views of one type of subsea equipment, in accordance with some embodiments.

FIG. 5A is a representation of one type of mobile device that includes an image sensor to generate an image of subsea equipment, in combination with a partial perspective view of a first side of the subsea equipment, in accordance with some embodiments.

FIG. 5B is a representation of the mobile device, in combination with a partial perspective view of a second side of the subsea equipment, in accordance with some embodiments.

FIG. 6 is a graphical representation of one type of mapping, in accordance with some embodiments.

FIG. 7 is a representation of one type of mobile device that includes a display to display a view, in combination with a partial perspective view of the first side of the subsea equipment, in accordance with some embodiments.

FIG. 8 is a representation of the mobile device, in combination with a partial perspective view of the first side of the subsea equipment, in accordance with some embodiments;

FIG. 9 is a representation of the mobile device, in combination with a partial perspective view of the first side of the subsea equipment, in accordance with some embodiments.

FIG. 10 is a representation of the mobile device, in combination with a partial perspective view of the first side of the subsea equipment, in accordance with some embodiments.

FIG. 11 is a representation of the mobile device, in combination with a partial perspective view of the first side of the subsea equipment, in accordance with some embodiments.

FIG. 12 is a representation of the mobile device, in combination with a partial perspective view of the first side of the subsea equipment, in accordance with some embodiments.

FIG. 13 is a representation of the mobile device, in combination with a partial perspective view of the first side of the subsea equipment, in accordance with some embodiments.

FIG. 14 is a representation of the mobile device, in combination with a partial perspective view of the first side of the subsea equipment, in accordance with some embodiments.

FIG. 15 is a representation of the mobile device, in combination with a partial perspective view of the first side of the subsea equipment, in accordance with some embodiments.

FIG. 16 is a representation of the mobile device, in combination with a partial perspective view of the second side of the subsea equipment, in accordance with some embodiments.

FIG. 17 is a representation of the mobile device displaying a view of an interface that lists procedures in an inspection process for the subsea equipment, in accordance with some embodiments.

FIG. 18 is a representation of the mobile device, in combination with a partial perspective view of the first side of the subsea equipment in an inspection procedure, in accordance with some embodiments.

FIG. 19 is a representation of the mobile device displaying a view of an interface that allows a user to input notes, capture and/or input pictures and/or provide other information, in accordance with some embodiments.

FIG. 20 is a representation of the mobile device displaying a view provided by an interface that allows a user to create and/or edit a plumbing table, in accordance with some embodiments.

FIG. 21 is a representation of the mobile device displaying a view provided by an interface that allows a user to access one or more hydraulic diagrams, in accordance with some embodiments.

FIG. 22 is a representation of the mobile device, in combination with a partial perspective view of the first side of the subsea equipment in a valve checking procedure, in accordance with some embodiments.

FIG. 23 is a representation of the mobile device, in combination with a partial perspective view of the second side of the subsea equipment, in accordance with some embodiments.

FIG. 24 is a representation of the mobile device displaying a view of an interface that allows the user to access (and navigate) the tool manual, in accordance with some embodiments.

FIG. 25 is a representation of the mobile device displaying a view of an interface that allows a user to access pictures of tools that may be used in association with the subsea equipment and/or inspection thereof, in accordance with some embodiments.

FIG. 26 is a representation of the mobile device, in combination with a partial perspective view of a third view of the subsea equipment, in accordance with some embodiments.

FIG. 27 is a block diagram in accordance with some embodiments.

FIGS. 28A-28C are a flow chart of a method, in accordance with some embodiments.

FIG. 29 is a representation of a software architecture 2900, in accordance with some embodiments.

FIG. 30 is a flow chart of a method, in accordance with some embodiments.

### DETAILED DESCRIPTION

Some aspects of this disclosure are directed to a method, apparatus, system and/or media for use in inspecting (and/or other activity associated with) subsea equipment in a topside environment.

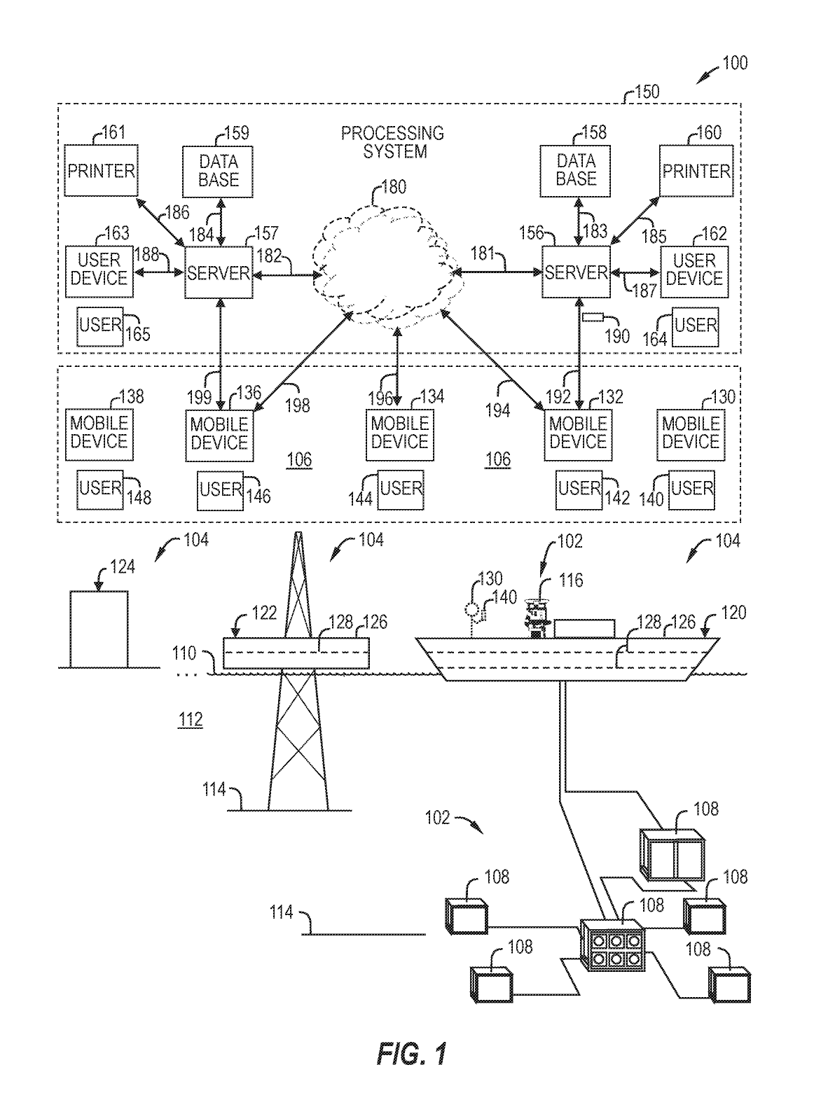

FIG. 1 is a block diagram of a system 100 in which subsea equipment may be inspected in a topside environment, in accordance with some embodiments.

Referring to FIG. 1, in accordance with some embodiments, the system 100 includes subsea equipment 102, one or more topside environments 104 and one or more mobile devices 106.

As used herein, the term “subsea equipment” means equipment (or portion(s) thereof) that may be used and/or installed beneath a surface of a sea (and/or other aquatic body). In some embodiments, subsea equipment may comprise subsea equipment that may be used in offshore oil and/or gas industries, underwater mining, underwater geology, offshore wind power, and/or marine biology.

Subsea equipment that may be used in offshore oil and/or gas industries may include subsea trees, manifolds, blowout preventers (BOPS) and/or other equipment (or portion(s) thereof) that may be used and/or installed beneath a surface of a sea (and/or other aquatic body). Subsea equipment that may be used in offshore oil and/or gas industries may also include tree running tools (TRTs) and/or other tool(s) (or portion(s) thereof) that may be used in installing and/or maintaining other subsea equipment beneath a surface of a sea (and/or other aquatic body).

In the illustrated embodiment, the subsea equipment 102 includes subsea equipment 108 that has been installed beneath a surface 110 of a sea 112 (e.g., on a sea floor 114) and subsea equipment 116 that is located in one or more of the one or more topside environments 104.

As used herein, a “topside environment” may include, but is not limited to, a deck (top and/or other deck) and/or other portion(s) of a ship (and/or other type of boat and/or other watercraft), a deck (top and/or other deck) and/or other portion(s) of an offshore platform (stationary, floating and/or other), onshore environments and/or air (and/or other gas) environments.

In the illustrated embodiment, the one or more topside environments 104 include a ship 120, an offshore platform 122 and a building 124 located onshore. The ship 120 and the offshore platform 122 may each include one or more decks, e.g., a top deck 126 and one or more lower deck(s) 128.

As used herein, the term “mobile device” means any type of mobile device.

In some embodiments, a mobile device includes one or more input device, one or more output device, one or more sensors, one or more processors and/or one or more memories.

A mobile device may or may not communicate with a network and/or other device.

If a mobile device includes one or more processors, the one or more processors may execute one or more programs to perform one or more tasks. In some embodiments, one or more of the one or more programs may communicate with the server 156, directly and/or indirectly, to request information (e.g., information 190) from and/or to provide information (e.g., information 190) to the server 156. In some embodiments, one or more of such programs may be a Web browser, or other mobile applications. In some embodiments, one or more portions of information received from and/or provided to a mobile device may be stored in the database 158.

In some embodiments, a mobile device may comprise a computing device that includes a processor, an image sensor, a display and a touch screen (and/or keyboard of miniature or other size).

As used herein, the term “image sensor” means any type of image sensor. In some embodiments, an image sensor may be a device that detects an image and provides information indicative thereof. In some embodiments, an image sensor may comprise charge coupled devices (CCD) and/or other active pixel sensors. In some embodiments, an image sensor may be part of a camera (a still, video or other type of camera).

As used herein, the term “display” means any type of display. In some embodiments, a display may be a device that presents information in a visual form. In some embodiments, a display may comprise a liquid crystal (LCD) display, a light emitting diode (LED) display, a gas plasma display, and/or a cathode ray tube (CRT) display.

In some embodiments, a mobile device may be designed to be used while held in one or two hands and/or to be wearable.

A mobile device that is designed to be used while held in one or two hands may comprise a laptop computer (full-size or any other size), a tablet computer (sometimes referred to as a tablet), a smart phone (or other type of mobile phone), a portable data assistant, a digital camera, an e reader, a media player, a game console, a smart card (other smart device), a usb flash drive and/or any other device designed to be used while held in one or two hands.

A mobile device designed to be wearable may comprise (i) eyeglasses having one or more input device, one or more sensors, one or more output device, one or more processor and/or one or more memory, (ii) a head-mounted apparatus (headset, helmet or other head mounted apparatus) having one or more input device, one or more output device, one or more processor and/or one or more memory, (iv) clothing having one or more input device, one or more output device, one or more processor and/or one or more memory and/or (v) any device that may be worn on, in and/or supported by: (a) a portion of a body and/or (b) clothing.

In the illustrated embodiment, the one or more mobile devices include mobile devices 130-138. In some embodiments, the one or more mobile devices 106 may be operated by one or more users, e.g., users 140-148. In some embodiments, one or more of such users may be a field service engineer and/or other person associated with subsea equipment and/or an inspection thereof.

The system 100 may further include a processing system 150.

As used herein, the term “processing system” means a system that includes at least one processor.

In some embodiments, the processing system 150 may include one or more servers, e.g., servers 156-157, one or more databases, e.g., databases 158-159, one or more printers, e.g., printers 160-161, and/or one or more user devices, e.g., user devices 162-163, which may be operated by one or more users, e.g., users 164-165. Each of the servers may be a file server, an email server, a web server and/or other type(s) of server. Each of the databases may store information used and/or collected by the processing system 150 and/or any other information. Each of the printers may be used to print files and/or other information. Each of the user devices may be a desktop computer and/or any other type of user device.

The processing system 150 may further include a plurality of communication links, e.g., communication links 180-188, that couple the one or more servers, e.g., servers 156-157, one or more database, e.g., databases 158-159, one or more printers, e.g., printers 160-161, and one or more user devices, e.g., user devices 162-163, to one another.

As used herein, the term “couple” means “couple directly” and/or “couple indirectly”.

In some embodiments, one or more of the communication links may define a network (or a portion thereof), e.g., a local area network and/or a wide area network, e.g., the Internet.

In some embodiments, one or more of the mobile devices, e.g., mobile devices 130-138, may be coupled to the processing system 150 via one or more communication links, e.g., one or more of communication links 192-199. In some embodiments, one or more of the communication links may define a network (or a portion thereof), e.g., a local area network and/or a wide area network, e.g., the Internet.

The system is not limited to the number and/or the types of devices that are shown in FIG. 1. In some embodiments, the system may include any number and/or type(s) of devices.

As stated above, subsea equipment is often inspected for damage and/or proper operation while located in a topside environment (on a ship, on a platform and/or some other topside environment), prior to installing and/or operating the subsea equipment beneath the surface of the sea and/or other aquatic body.

The inspection process is traditionally performed by one or more field service engineers and may be time consuming. Field service engineers often use lengthy service manuals that consist of large part of two dimensional diagrams and technical drawings, from which the engineers abstract information, which they then use to locate and inspect one or more portions of the subsea equipment.

In addition to performing an inspection, field service engineers must often create a record of the procedures that they use and the findings that they make. For example, a field service engineer must register important information (e.g., pressure applied during tests for detection of leakages, any damage suffered by the equipment during transport, modifications that are made to subsea equipment in a topside environment) for subsequent documentation and reporting. The traditional practice is to manually register the important information in a tally book and to take pictures with a still camera. The information and pictures are subsequently compiled into a service report using a desktop computer in a topside environment. In particular, the information that is registered in the tally book is transcribed into an electronic text document. The pictures are downloaded from the camera and attached to the electronic text document. In addition, during flushing tests, a field service engineer must create a plumbing table, which maps each connection between several different pieces of equipment that are involved in an installation (e.g., workover panel, reel, tools and a subsea tree).

In all, the process may take more than a day. To help keep the amount of time that is needed to a minimum, multiple shifts of field service engineers may be utilized, thereby allowing the process to continue round the clock (twenty four hours per day). As a result, a field service engineer that completes a certain portion of the inspection process may be a different field service engineer than started such portion of the inspection process.

The industry is currently facing a shortage of field service engineers and a high percentage of very experienced field service engineers (sometimes with more than thirty (30) years of experience) are expected to retire within the next five (5) years. At the same time, the process to qualify a new field service engineer is a long and costly.

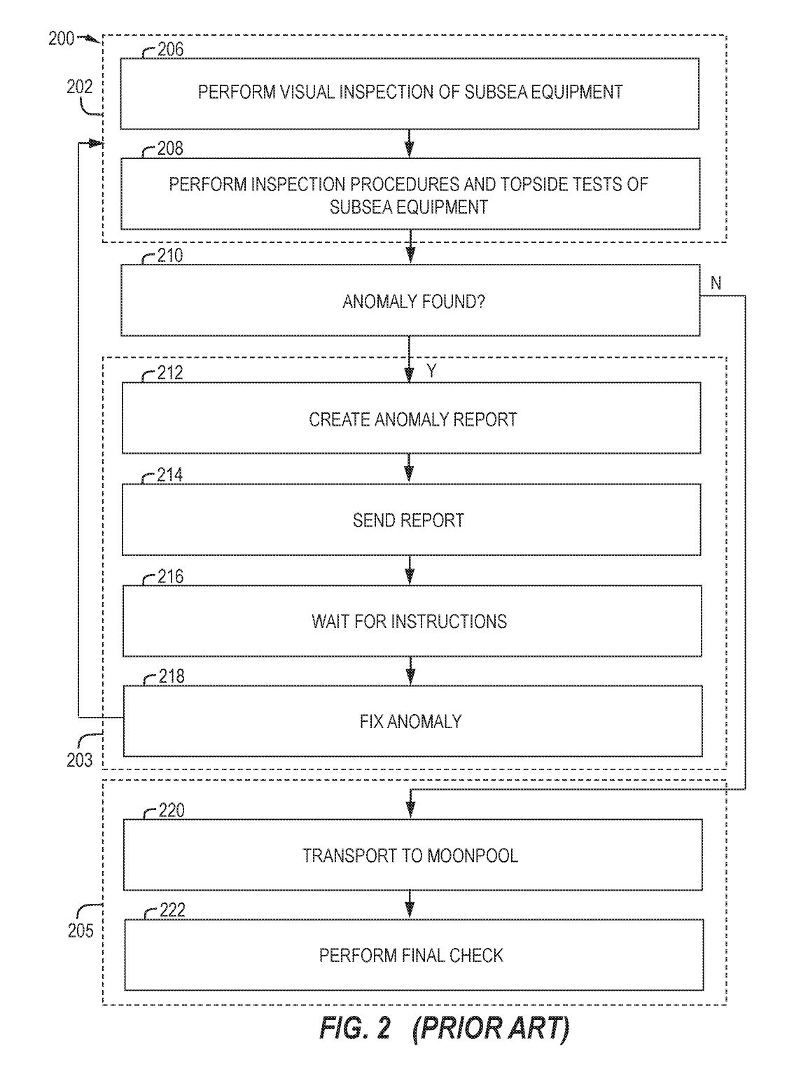

FIG. 2 is a flow chart of a prior art method 200 that is traditionally used to inspect subsea equipment that is located in a topside environment.

Referring to FIG. 2, the method 200 includes an inspection portion 202, a corrective action portion 203 and a transport and a final inspection portion 204.

At 206, in the inspection portion 202, the method includes performing a visual inspection of subsea equipment located in a topside environment.

At 208, the method further includes performing inspection procedures and topside tests of the subsea equipment located in a topside environment.

At 210, it is determined if any damage and/or other anomaly was found in performing the inspection portion 202.

If any damage and/or other anomaly was found, the method proceeds to the corrective action portion 203.

At 212, in the corrective action portion 203, the method includes creating an anomaly report. This report is traditionally created as follows. First, a field service engineer records information describing damage on a piece of paper. The field service engineer then relocates to a room with a desktop computer, and enters the information into the computer.

At 214, the method further includes waiting for instructions, and at 216, the anomaly is fixed. Traditionally, experts authorize a resolution to fix an anomaly and the field service engineer then fixes the anomaly.

The method may then return to the inspection portion 202, to continue and/or repeat one or more portions thereof.

At 210, it is determined if any additional damage and/or other anomaly was found.

If any additional damage and/or other anomaly was found, the method returns to the corrective action portion 203.

If no damage and/or other anomaly is found, the method proceeds to the transport portion and final inspection portion 204.

At 220, in the transport and final inspection portion 204, the method includes transporting the subsea equipment to a moonpool, and at 222, a final check is performed.

As stated above, it has been determined that it is possible to assist a field service engineer and/or other person, in one or more respects, in regard to inspecting (and/or other activity associated with) subsea equipment located in a topside environment.

In accordance with some embodiments, a field service engineer and/or other person may be assisted, in one or more respects, by one or more of the mobile devices 106 and/or other portion(s) of the system 100, in identifying subsea equipment that is located in a topside environment, locating one or more portions of the subsea equipment that are to be inspected while the subsea equipment is located in a topside environment, inspecting one or more portions of subsea equipment that is located in a topside environment and/or other activity associated with subsea equipment located in a topside environment.

In some embodiments, a user may be guided, at least in part, through one or more portions of an inspection of (and/or other activity associated with) subsea equipment that is located in a topside environment.

In some embodiments, a user may be assisted, in one or more respects, in regard to one or more portions of the method 200.

In some embodiments, a user may be guided, at least in part, through one or more portions of the method 200.

Briefly, in some embodiments, a user (a field service engineer and/or other person) may position a mobile device, which in some embodiments may be a wearable device, having an image sensor directed at subsea equipment located in a topside environment. The image sensor may subsequently capture (or generate in any other way) an image of the subsea equipment, and the subsea equipment may be identified (in terms of type and/or any other term(s)) based at least in part on the image (by analysis of the image and/or otherwise). A mobile device (which may be the mobile device having the image sensor or a different mobile device), which in some embodiments may be a wearable device, may thereafter display a view that includes contextual information to support the user in inspection (and/or any other activity related to) subsea equipment located in a topside environment.

In some embodiments, the contextual information may assist in identifying subsea equipment located in a topside environment, locating one or more portions of subsea equipment that are to be inspected, inspecting one or more portions of subsea equipment and/or other activity associated with subsea equipment located in a topside environment.

In some embodiments, the contextual information may include: (i) a representation of the subsea equipment, and (ii) an indicator that indicates a portion of the representation that includes a representation of one or more portions of the subsea equipment that are to be inspected while the subsea equipment is located in a topside environment.

In some embodiments, the contextual information may further and/or may alternatively include a sequence of steps that may need to be executed by a user during an inspection process.

In some embodiments, the contextual information may further and/or may alternatively include any other information that may be relevant to an operation that should be performed. In some embodiments, the method and/or apparatus has the technical effect of assisting the user in locating one or more portions of the subsea equipment that are to be inspected while the subsea equipment is located in a topside environment.

In some embodiments, the method and/or apparatus also has the technical effect of reducing the need for a field service engineer (and/or another person) to abstract information from two dimensional diagrams and technical drawings in the lengthy service manual that is often used in order to locate the one or more portions of the subsea equipment (which unlike the two dimensional drawings, is a three dimensional object) that are to be inspected while the subsea equipment is located in a topside environment, and thereby reduces the level of abstraction that is needed on the part of a field service engineer (and/or another person) in order to locate the one or more portions of the subsea equipment that are to be inspected while the subsea equipment is located in a topside environment.

In some embodiments, the method and/or apparatus also has the technical effect of reducing the amount of time that may be needed to perform an inspection and/or other activity. This may present one or more advantages. First, time may be critical. Thus, any amount of time that may be saved may be important. Second, any amount of time that may be saved may represent considerable savings in terms of resources and/or costs.

Some embodiments also has the technical effect of speeding up the learning curve of need field service engineers.

In some embodiments, the representation of the subsea equipment may be from a perspective that is the same as, and/or similar to, a perspective that the user has of the subsea equipment.

A representation that is from a perspective that is the same as, and/or similar to, a perspective that the user has of the subsea equipment may have the technical effect of further assisting the user in locating one or more portions of the subsea equipment that area to be inspected while the subsea equipment is located in a topside environment.

In some embodiments, a user may also be provided with the ability to log and/or otherwise create a record of findings (of any anomalies and/or other findings) during an inspection. By doing this during an inspection (rather than after an inspection), safety and efficiency are increased.

The ability to log and/or otherwise create a record of procedures that are performed during an inspection may have the technical effect of increasing compliance and thereby increasing safety.

In some embodiments, the representation of the subsea equipment and the one or more portions of the subsea equipment that are to be inspected while the subsea equipment is located in a topside environment may be determined by a processor in the mobile device that includes the image sensor, a processor in the mobile device that includes the display and/or a processor in one or more other portion(s) of the system 100.

In some embodiments, connectivity to shore locations may be limited, for example, due to restrictions and/or other constraints associated with a satellite link and/or other type of communication link. In such embodiments, it may be desirable to use one or more processors in, and/or otherwise available from, the topside environment.

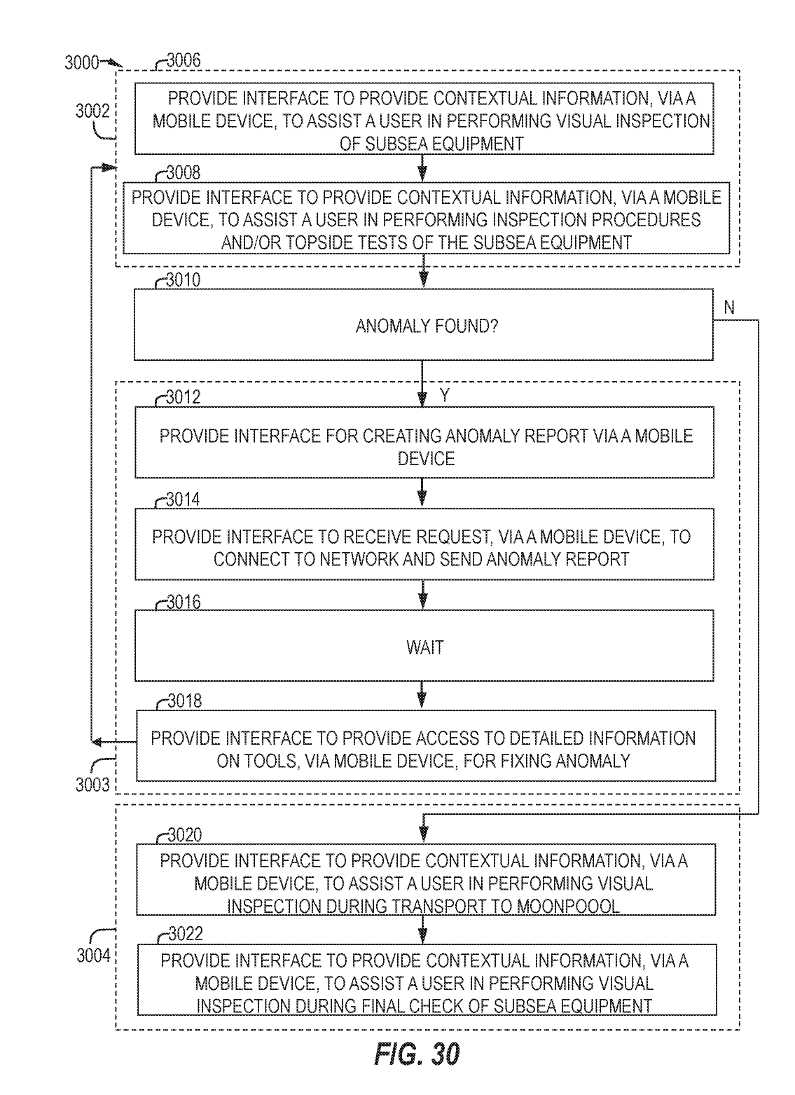

FIG. 30 is a flow chart of a method 3000 that may be used in inspecting and/or other activity associated with subsea equipment located in a topside environment, in accordance with some embodiments.

As further described herein, the method may make use of a mobile device, which, in some embodiments, may be a wearable device, to capture (or generate in any other way) an image of the subsea equipment. In some embodiments, the subsea equipment may be identified (in terms of type and/or any other term(s)) based at least in part on the image (by analysis of the image and/or otherwise). The method may make further use of a mobile device, which in some embodiments, may be a wearable device, to provide the contextual information to support the user in performing the visual inspection (and/or other activities relating to) the subsea equipment located in a topside environment

In some embodiments, the method (or portion(s) thereof) may thereby reduce the need for a user (a field service engineer and/or other person) to abstract information from two dimensional diagrams and technical drawings in order to perform the inspection activities on the subsea equipment (which unlike two dimensional drawings, is a three dimensional object).

In some embodiments, the method (or portion(s) thereof) may help a user (a field engineer and/or other person) to perform a faster and more accurate inspection.

In some embodiments, the method (or portion(s) thereof) may also manage an inspection (or portion(s) thereof) of subsea equipment located in a topside environment

Referring to FIG. 30, in accordance with some embodiments, the method 3000 may include an inspection portion 3002, a corrective action portion 3003 and a transport and a final inspection portion 3004.

At 3006, in the inspection portion 3002, the method may include providing an interface to provide contextual information, via a mobile device, to assist a user in performing a visual inspection of (and/or other activities relating to) subsea equipment located in a topside environment.

In some embodiments, the interface may be provided after a camera of a mobile device is used to capture (or otherwise generate) an image of subsea equipment, and after the image has been analyzed to identify the type of subsea equipment in the image.

In some embodiments, the contextual information may include: (i) a representation of the subsea equipment, and (ii) an indicator that indicates a portion of the representation that includes a representation of one or more portions of the subsea equipment that are to be inspected while the subsea equipment that is located in a topside environment.

In some embodiments, the interface may assist a user in visualizing details of the subsea equipment and performing a visual inspection of the subsea equipment to try to identify any potential damage.

In some embodiments, the interface may guide a user in performing a visual inspection of (and/or other activities relating to) subsea equipment located in a topside environment.

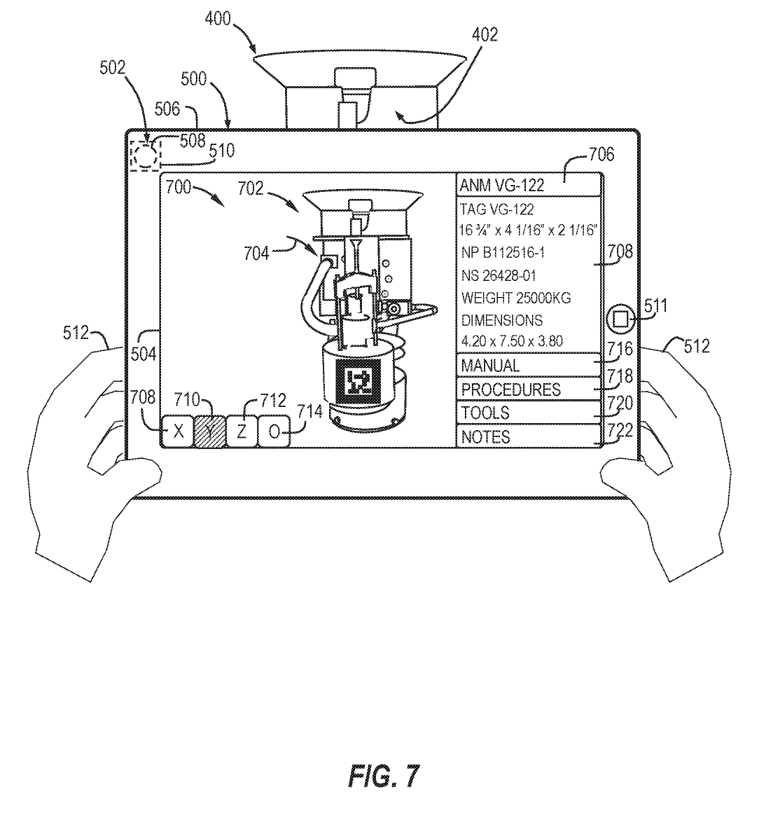

In some embodiments, the interface may comprise one or more of the views shown in, and/or described with respect to, FIGS. 7-16 and/or 19.

In some embodiments, the indicator may highlight and/or otherwise indicate a specific portion of the representation that includes a representation of one or more portions of the subsea equipment that are to be inspected. Indicators that may be provided in some embodiments are shown in, and/or described with respect to, FIGS. 7-9.

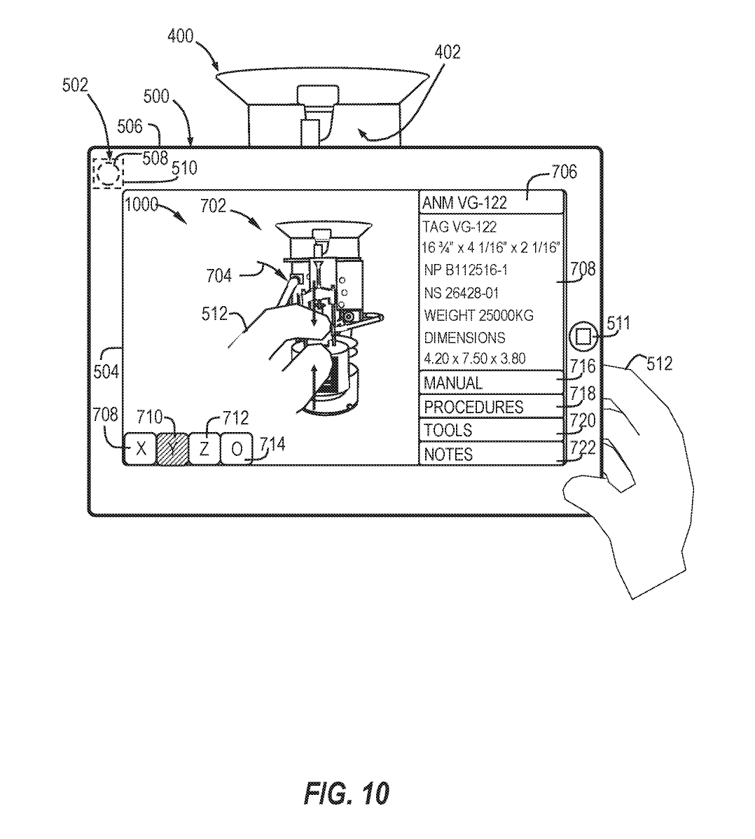

In some embodiments, the user may interact with the representation via a user interface. In some embodiments, the interaction may be via finger gestures performed on a screen of a tablet and/or other mobile device and/or gestures made in the air in case of a wearable device such as a smart glass with finger tracking capabilities. Interactions that may be provided in some embodiments are shown in, and/or described with respect to, FIGS. 10-15.

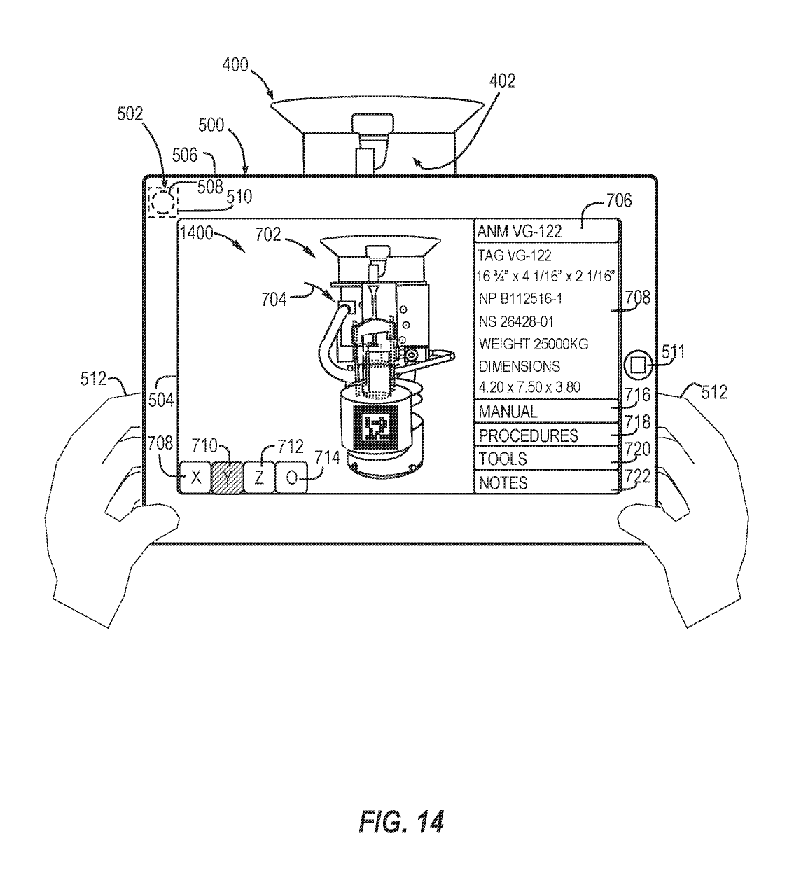

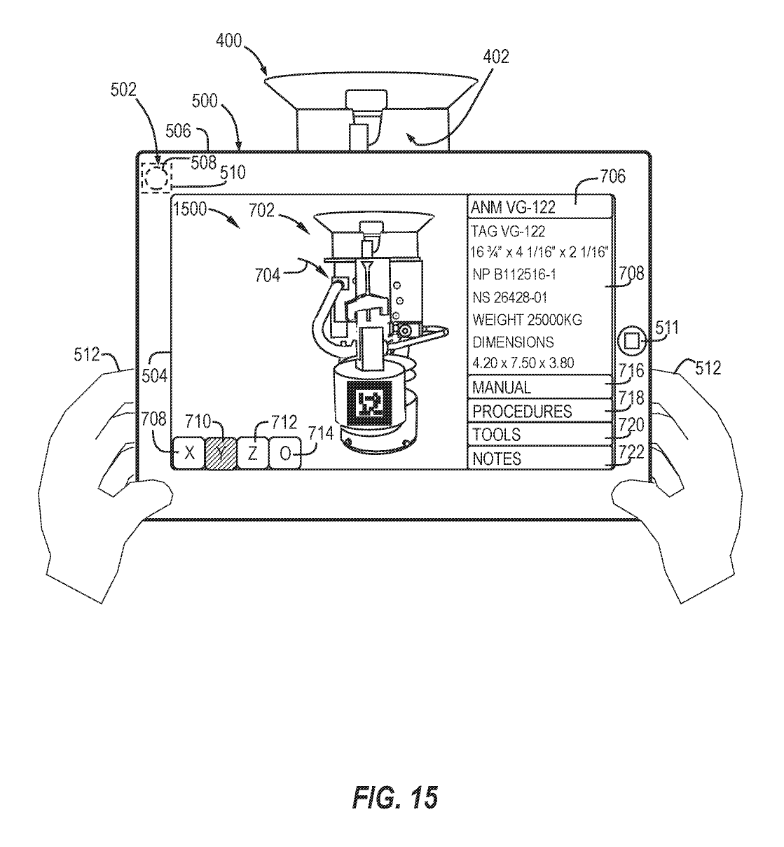

In some embodiments, the representation may have different levels of opacity and/or transparency. Representations that have different levels of opacity and/or transparency and that may be provided in some embodiments are shown in, and/or described with respect to, FIGS. 14-15.

As further described below, in some embodiments, if the user identifies any kind of damage, the user will create an anomaly report.

In some embodiments, the interface may also assist a user in adding notes, pictures and/or other information to an inspection report. In some embodiments, the notes, pictures and/or other information may be added to a section in the inspection report that relates to a current procedure (of a set procedures) that is being performed.

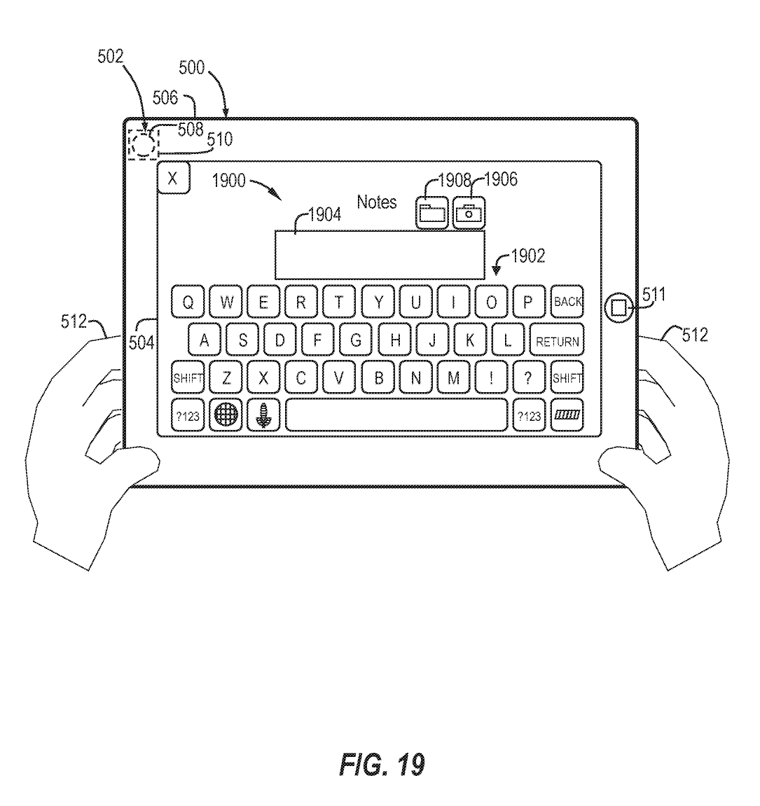

A view that may be provided in some embodiments is shown in FIG. 7, which as further described below, includes a graphical tool 722, which may be activated by a user. The activation of the graphical tool 722 may provide an interface to be displayed on the mobile device which allows a user to input notes, capture and/or input pictures and/or provide other information. A view of an interface that allows a user to input notes, capture and/or input pictures and/or provide other information and that may be provided in some embodiments is shown in, and/or described with respect to, FIG. 19.

At 3008, the method may further include providing an interface to provide contextual information, via a mobile device, to assist a user in performing inspection procedures and/or topside tests of (and/or other activities relating to) the subsea equipment located in a topside environment.

In some embodiments, the interface guides a user in performing the inspection procedures and/or topside tests of (and/or other activities relating to) the subsea equipment.

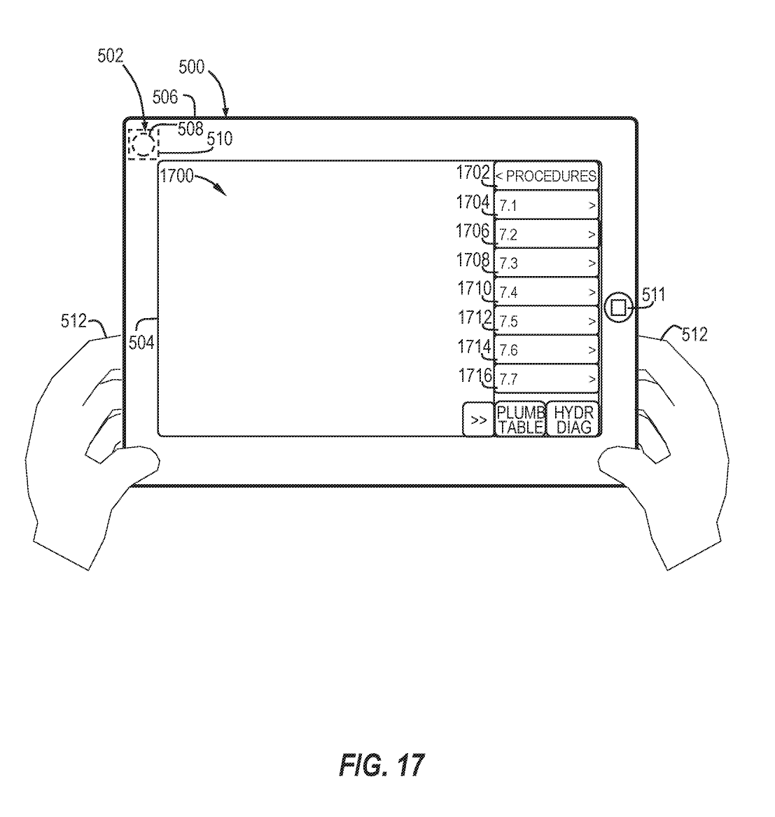

In some embodiments, the interface may comprise one or more of the interfaces shown in, and/or described with respect to, FIGS. 17-23 and/or 26.

In some embodiments, the interface may guide a user in performance of a set of procedures that must be performed on the subsea equipment. A set of procedures that must be performed may depend on the type of subsea equipment and the reason for the inspection (sometimes referred to herein as the type of operation). In some embodiments, three different types of operations may be supported for each type of subsea equipment: (1) installation of the subsea equipment, (2) workover of the subsea equipment and (3) removal of the subsea equipment.

In some embodiments, the interface may provide all the information that the user will need in the context of the type of operation being performed.

In some embodiments, the set of procedures to be performed in any given situation are predefined by a specification.

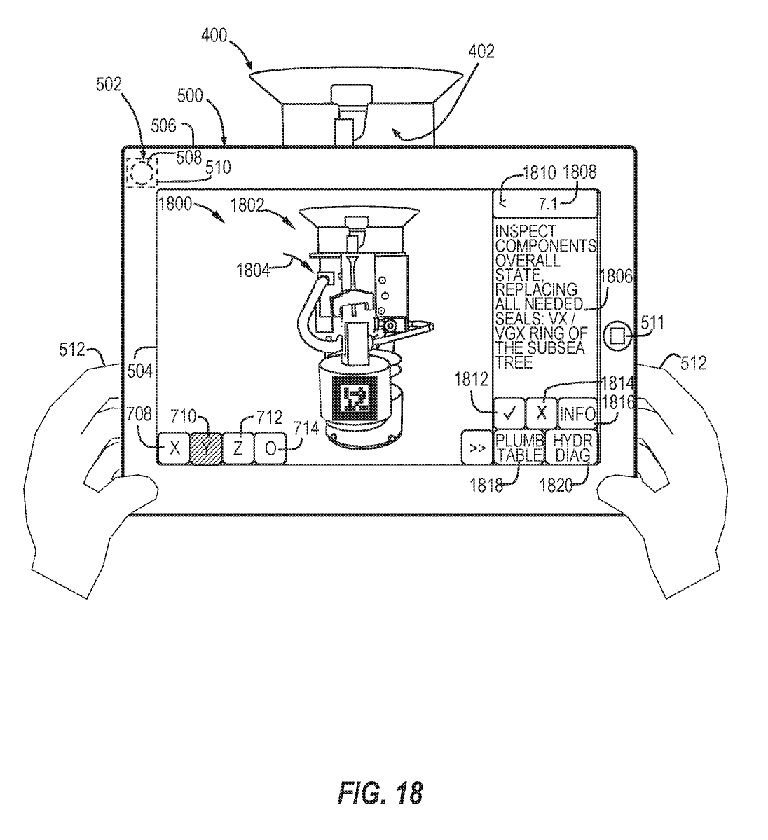

In some embodiments, the interface may enable a user to set a status for each procedure (of a set of procedures) by activing a single button and/or other type of graphical tool. A view that may be provided in some embodiments is shown in, and/or described with respect to, FIG. 18, which as further described below, includes a graphical tool 1812, which may be activated by a user to indicate that a procedure (of a set procedures) has been performed.

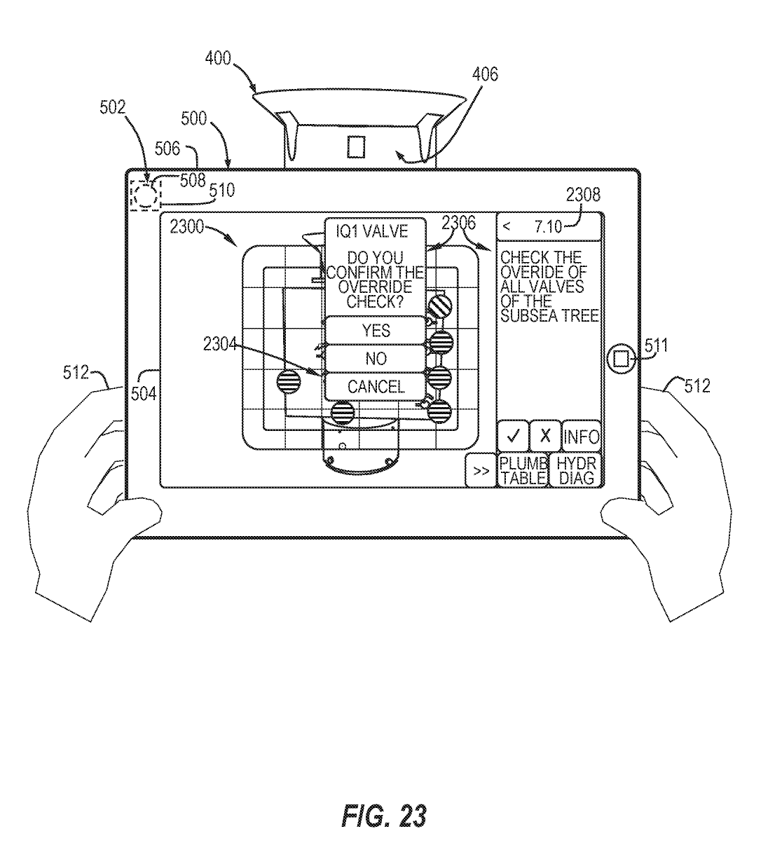

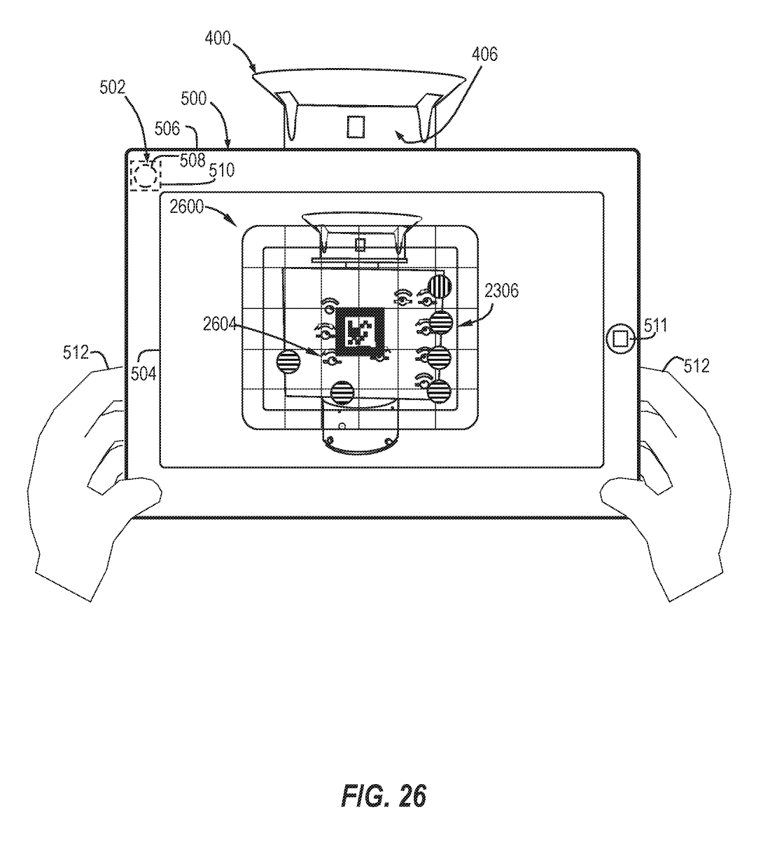

In some embodiments, the interface may support testing of valves. Views that may be provided in some embodiments are shown in, and/or described with respect to, FIGS. 23 and 26.

In some embodiments, valves may be tested in three different modes: (i) override, resulting in success or failure; (ii) number of turns, resulting in the information about the number of turns the valve actually accepted versus the expected number in the technical specification and (iii) a combined test or some valves must be closed and others opened also resulting in success or failure. The mode(s) used in any given situation may depend on the procedure being performed.

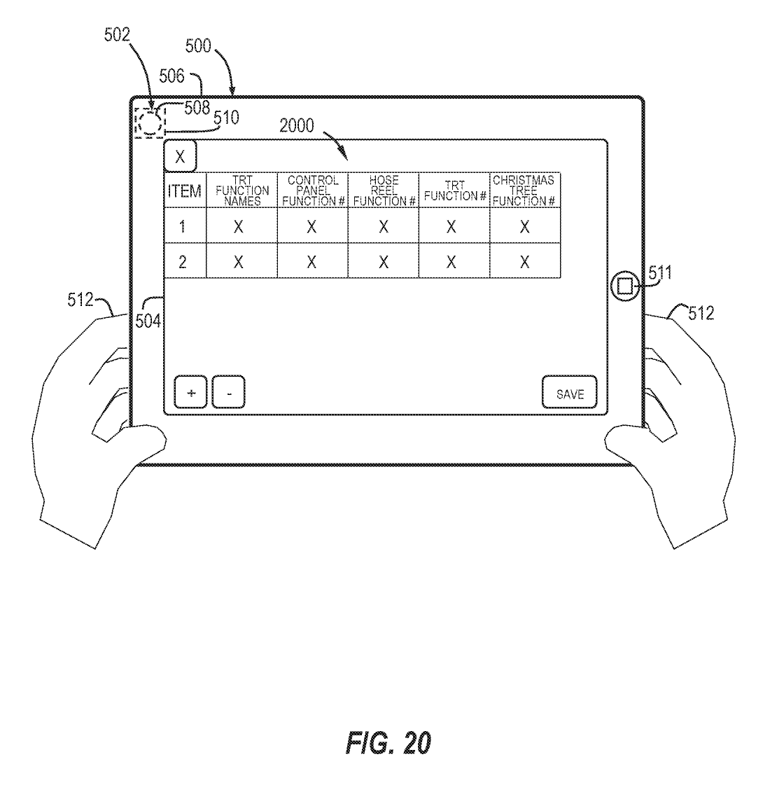

In some embodiments, the interface may assist in creation and/or editing a plumbing table during a deployment and/or other point(s) in time. A view that may be provided in some embodiments is shown in, and/or described with respect to, FIG. 18, which as further described below, includes a graphical tool 1818, which may be activated by a user to cause the mobile device to provide an interface that allows a user to create and/or edit a configurable table from which a user may create a plumbing table that shows results of tests performed during a deployment and/or other point(s) in time. A view of an interface that allows a user to create and/or edit a configurable table from which a user may create a plumbing table that shows results of tests and that may be provided in some embodiments is shown in, and/or described with respect to, FIG. 20.

In some embodiments, the interface may also assist a user in adding notes, pictures and/or other information to an inspection report. In some embodiments, the notes, pictures and/or other information may be added to a section in the inspection report that relates to a current procedure (of a set procedures) that is being performed.

A view that may be provided in some embodiments is shown in FIG. 7, which as further described below, includes a graphical tool 1816, which may be activated by a user to cause a mobile device to provide an interface that allows a user to input notes, capture and/or input pictures and/or provide other information. A view of an interface that allows a user to input notes, capture and/or input pictures and/or provide other information and that may be provided in some embodiments is shown in, and/or described with respect to, FIG. 19.

At 3010, it may be determined if any damage and/or other anomaly was found in performing the inspection portion 3002.

If any damage and/or other anomaly was found, the method may proceed to the corrective action portion 3003.

At 3012, in the corrective action portion 3003, the method may further include providing an interface for creating and/or adding to an anomaly report via a mobile device.

In some embodiments, the anomaly report may describe any damage found, possible causes of the damage and how the causes and/or damage may be addressed.

As stated above, this report is traditionally created as follows. First, a field service engineer records information describing damage on a piece of paper. The field service engineer then relocates to a room with a desktop computer, and enters the information into the computer.

The interface for creating and/or adding to an anomaly report, via a mobile device, allows a user to create/add to an anomaly report without the need to write the description of the damage on a piece of paper and then relocate to a room with a computer, and then enter the same information into the computer.

At 3014, the method may further include proving an interface to receive a request, via a mobile device, to connect to a network and send the anomaly report.

Traditionally, a field service engineer uses the computer into which the information was entered to send the anomaly report to experts that are able to analyze the damage and authorize resolutions.

In some embodiments, the interface to receive a request, via a mobile device, to connect to a network and send the anomaly report allows a user to connect to an available network and send the anomaly report in real time and/or without relocating to a room with a computer.

At 3016, the method may further include waiting for instructions.

At 3018, the method may further include providing an interface to provide access to detailed information on tools for fixing the anomaly, via a mobile device.

As stated above, experts traditionally authorize a resolution to fix an anomaly and the field service engineer then fixes the anomaly.

A field service engineer may use one or more tools in fixing the anomaly.

The interface provides access to manuals, pictures and/or other detailed information on such tools.

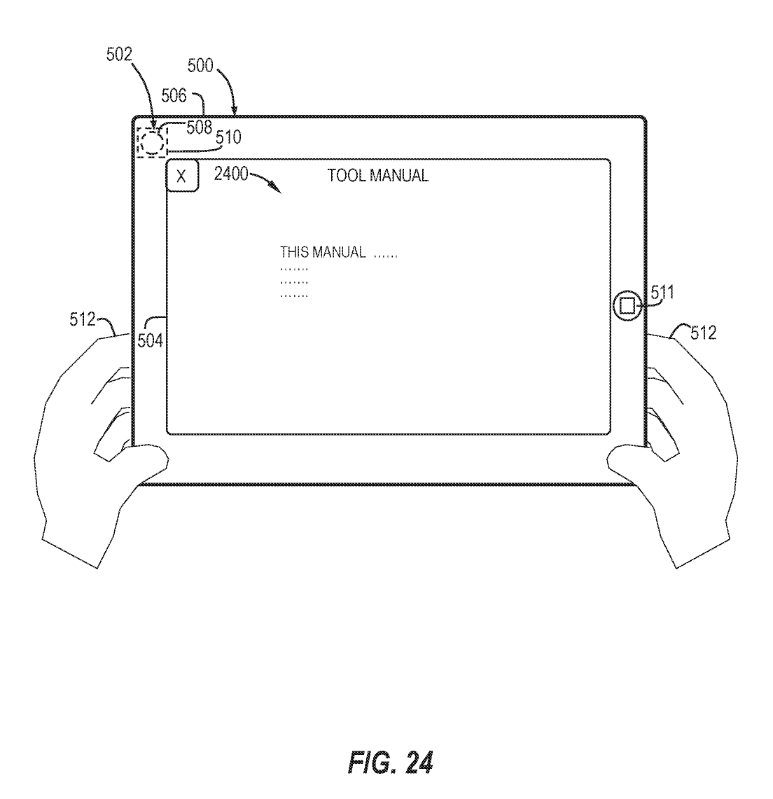

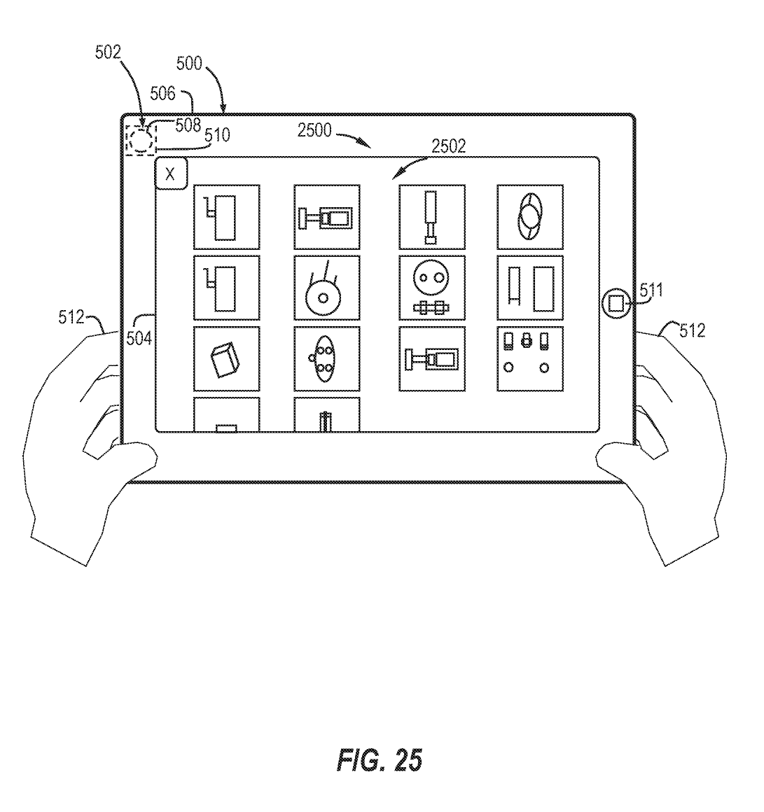

A view that may be provided in some embodiments is shown in, and/or described with respect to, FIG. 7, which as further described below, includes a graphical tool 716 that may be activated by a user to cause a mobile device to provide an interface that allows the user to access a tool manual, and which as further described below, further includes a graphical tool 720 that may be activated by a user to cause a mobile device to provide an interface that allows a user to access pictures of tools. A view of an interface that allows the user to access a tool manual and that may be used in some embodiments is shown in, and/or described with respect to, FIG. 24. A view of an interface that allows the user to access pictures of tools and that may be used in some embodiments is shown in, and/or described with respect to, FIG. 25.

The method may then return to the inspection portion 3002, to continue and/or repeat one or more portions thereof.

At 3010, it is determined if any additional damage and/or other anomaly was found.

If any additional damage and/or other anomaly was found, the method may return to the corrective action portion 3003.

If no damage and/or other anomaly is found, the method may proceed to the transport portion and final inspection portion 3004.

At 3020, in the transport and final inspection portion 3004, the method may further include providing an interface to provide contextual information, via a mobile device, to assist a user in visual inspection of subsea equipment during transport of the subsea equipment to a moonpool.

During transport of the subsea equipment, the field service engineer and/or other person observes the subsea equipment as it is moved (to a moonpool to be submerged) and determines if there is any remaining damage on the subsea equipment.

The interface may guide a user in a visual inspection, assist a user in adding to the inspection report and/or allow a user to return to the corrective action portion 3003 if any damage is observed.

In some embodiments, the interface may also assist a user in adding notes, pictures and/or other information to an inspection report.

At 3022, the method may further include providing an interface to provide contextual information, via a mobile device, to assist a user in visual inspection of subsea equipment during a final check of the subsea equipment.

In some embodiments, the interface may also assist a user in adding notes, pictures and/or other information to an inspection report.

In some embodiments, the method 3000 may further comprise automatically synchronizing with a central repository whenever a connection to the central repository is available. In some embodiments, automatically synchronizing may comprise automatically downloading relevant material e.g.: manuals, 3D models, procedures, and uploading a log of activities that have been performed and photos that have been taken and/or an inspection report including the above.

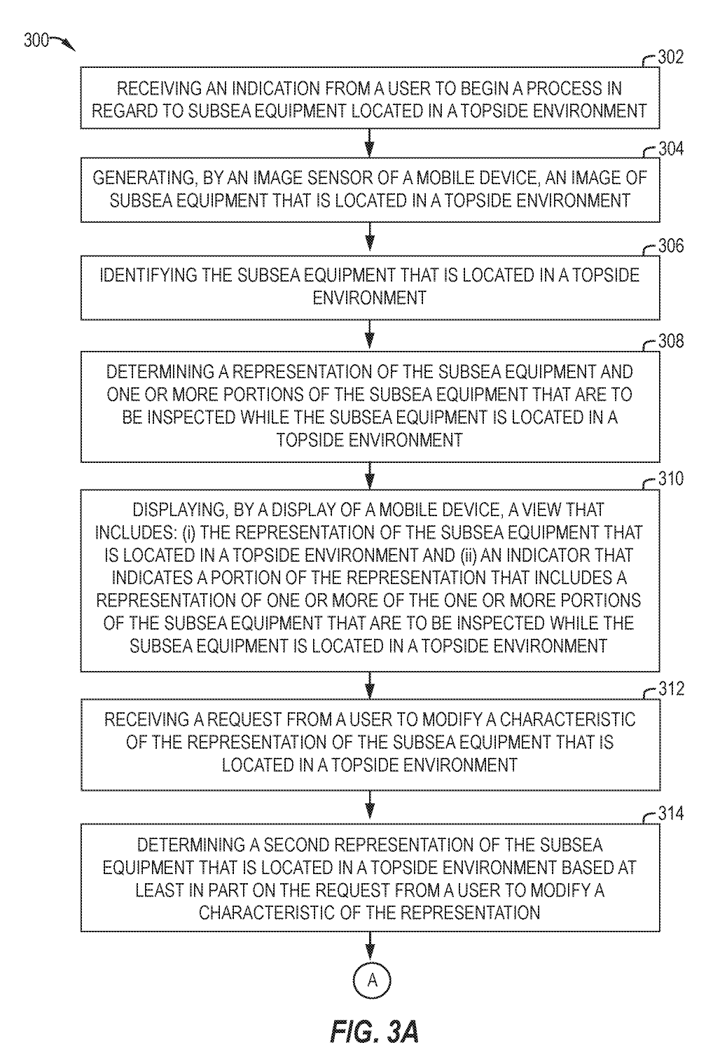

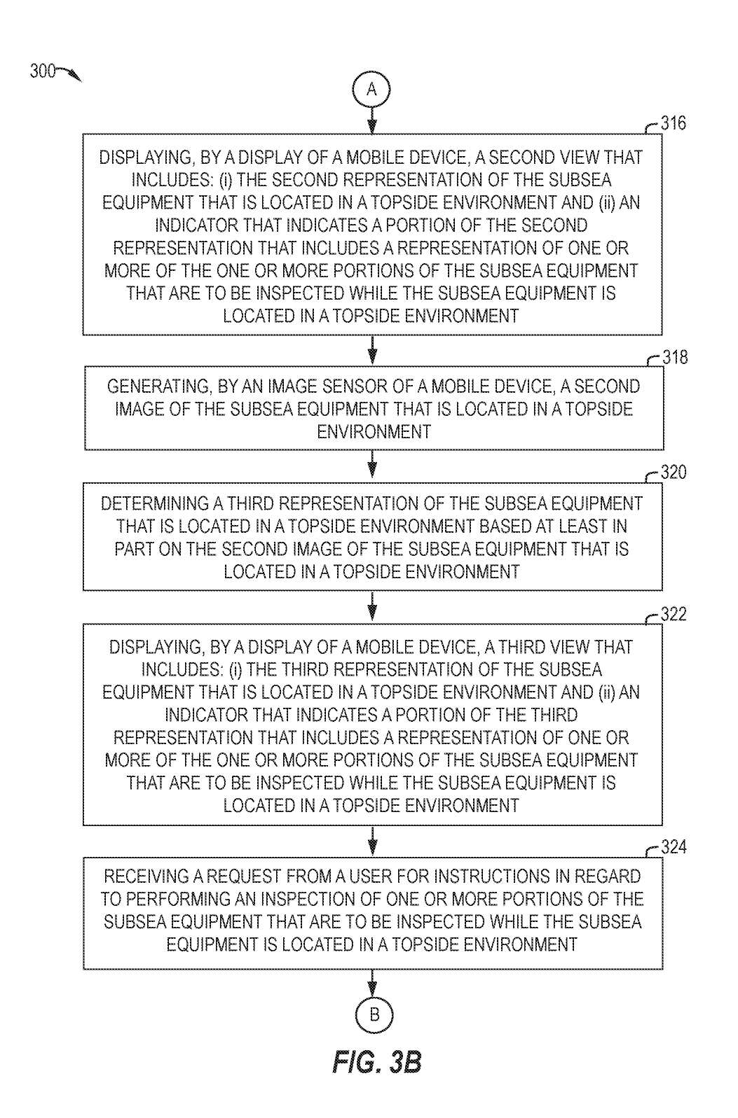

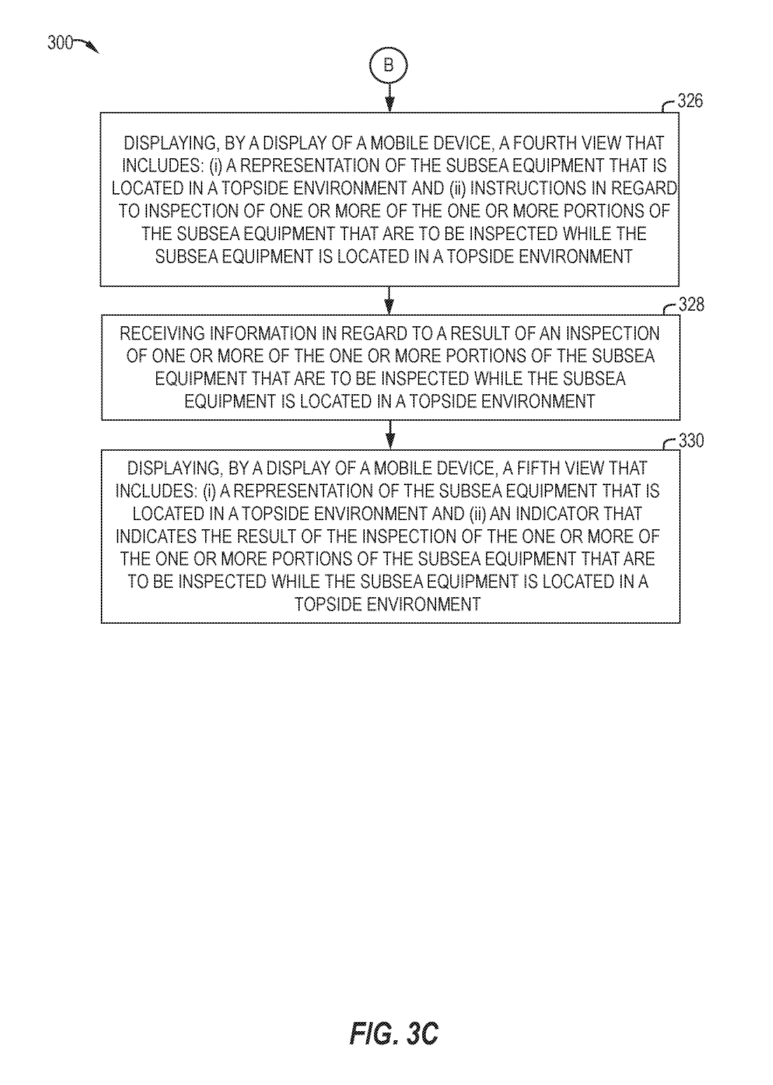

FIG. 3A-3C are a flow chart of a method 300 that may be used in providing contextual information and/or other activity associated with subsea equipment located in a topside environment, in accordance with some embodiments.

In some embodiments, the contextual information may assist in identifying subsea equipment located in a topside environment, locating one or more portions of subsea equipment that are to be inspected while the subsea equipment is located in a topside environment, inspecting one or more portions of subsea equipment located in a topside environment and/or other activity associated with subsea equipment located in a topside environment.

In some embodiments, one or more portions of the method 300 may be used in the method 3000 (FIG. 30).

In some embodiments, the method 300 (and/or any other method disclosed herein) or one or more portions thereof, may be performed by one or more mobile devices, e.g., one or more of mobile devices 130-138, one or more portions of the processing system 150 and/or one or more other portions of the system 100.

The method 300 is not limited to the order shown in the flow chart. Rather, embodiments of the method 300 may be performed in any order that is practicable. For that matter, unless stated otherwise, any method disclosed herein may be performed in any order that is practicable.

In some embodiments, one or more portions of the method 300 may be performed without one or more other portions of the method 300.

In some embodiments, one or more portions of the method 300 (and/or any other method disclosed herein) may be performed in combination with one or more other methods and/or portions thereof.

In some embodiments, a non-transitory computer readable medium may have instructions stored thereon, which if executed by a machine result in performance of the method 300 (and/or any other method disclosed herein) or one or more portions thereof.

Referring to FIGS. 3A-3C, in accordance with some embodiments, at 302, the method may include receiving an indication from a user (a field service engineer and/or other person) to begin a process in regard to subsea equipment located in a topside environment.

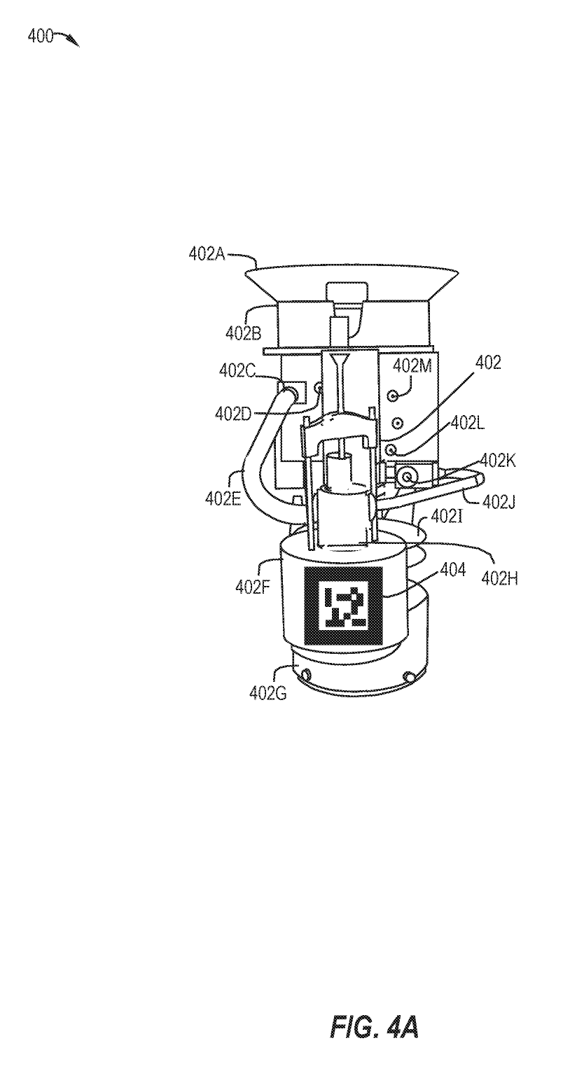

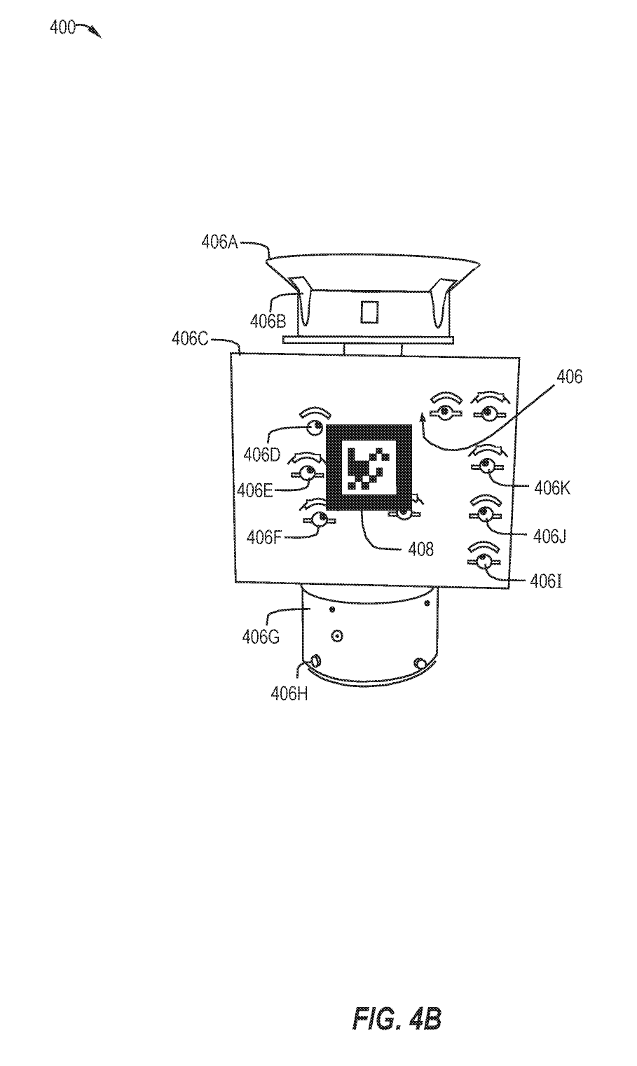

FIGS. 4A-4B are perspective views of one type of subsea equipment 400, in accordance with some embodiments.

Referring to FIG. 4A, in accordance with some embodiments, the subsea equipment 400 may have a first side 402, which may have one or more portions, e.g., portions 402A-402M. In some embodiments, one or more of the portions may comprise an inlet or an outlet for a hose, pipe, conduit or other type of line through which fluid and/or other material may travel.

In some embodiments, one or more of the one or more portions, e.g., 402C, may be a portion that is to be inspected while the subsea equipment 400 is located in a topside environment.

The first side 402 of the subsea equipment may include one or more features that may be used in identifying the first side 402 (and/or one or more portions thereof) and/or in identifying the subsea equipment 400 in general (and/or one or more portions thereof).

The one or more features may be any type(s) of feature(s). In some embodiments, the one or more features may include one or more structural features that may be required for proper operation of the subsea equipment. In some embodiments, the one or more features may include one or more features that are not structural features required for proper operation of the subsea equipment but rather are provided for identification purposes.

Features that are not structural features required for proper operation of the subsea equipment but rather may be provided for identification purposes may include: one or more quick response (QR) codes, e.g., QR code 404, and/or other type(s) of machine readable code(s), one or more part numbers and/or other description(s).

In some embodiments, one or more of the identified features may comprise a tag associated with the subsea equipment.

As used herein, the term “tag” means any type of tag. In some embodiments, the tag comprises a quick response (QR) code and/or other type(s) of machine readable code. In some embodiments, the tag comprises a part number and/or other type(s) of human readable description.

In some embodiments, one or more of the features may be disposed on a label that may be disposed on the first side 402.

Referring to FIG. 4B, in accordance with some embodiments, the subsea equipment 400 may have a second side 406, which may have one or more portions, e.g., portions 406A-406K. In some embodiments, one or more of the portions may comprise an inlet or an outlet for a hose, pipe, conduit or other type of line through which fluid and/or other material may travel.

In some embodiments, one or more of the portions, e.g., portion 406F, may be a portion that is to be inspected while the subsea equipment 400 is located in a topside environment.

The second side 406 may include one or more features that may be used in identifying the second side 406 (and/or one or more portions thereof) and/or in identifying the subsea equipment 400 in general (and/or one or more portions thereof).

The one or more features may be any type(s) of feature(s). In some embodiments, the one or more features may include one or more structural features that may be required for proper operation of the subsea equipment. In some embodiments, the one or more features may include one or more features that are not structural features required for proper operation of the subsea equipment but rather are provided for identification purposes.

Features that are not structural features required for proper operation of the subsea equipment but rather are provided for identification purposes may include: one or more quick response (QR) codes, e.g., QR code 408, and/or other type(s) of machine readable code(s), one or more part numbers and/or other description(s).

In some embodiments, one or more of the features may be disposed on a label that may be disposed on the second side 406.

Referring again to FIGS. 3A-3C, at 304, the method may further include generating, by an image sensor of a mobile device, an image of subsea equipment that is located in a topside environment.

In some embodiments, a user will have positioned the mobile device such the image sensor of the mobile device is directed toward the subsea equipment located in a topside environment.

As further described below, in some embodiments, the user will have positioned the mobile device such that the image sensor has a perspective of the subsea equipment that is the same as, and/or similar to, a perspective that the user has of the subsea equipment. Such positioning may result in the image of the subsea equipment being from a perspective that is the same as, and/or similar to, a perspective that the user has of the subsea equipment.

The image may have any form. In some embodiments, the image may comprise a plurality of pixel values and/or other information that defines the image.

The image may be generated in any manner. In some embodiments, the image may be generated as a stand-alone image. In some embodiments, the image may be generated as part of a video or other sequence of images (i.e., as an image in a sequence of images). In some embodiments, a sequence of images may comprise a sequence of images in a live feed.

The image sensor may be any type of image sensor. In some embodiments, the image sensor may be part of a camera that captures the image as a photograph and/or as part of a video.

The mobile device may be any type of mobile device that includes an image sensor.

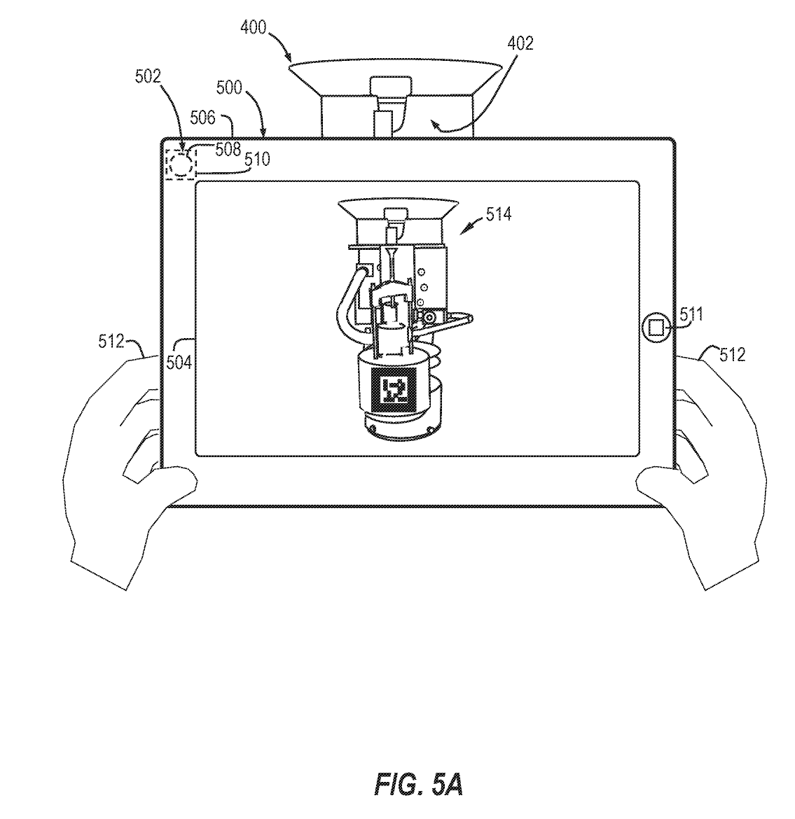

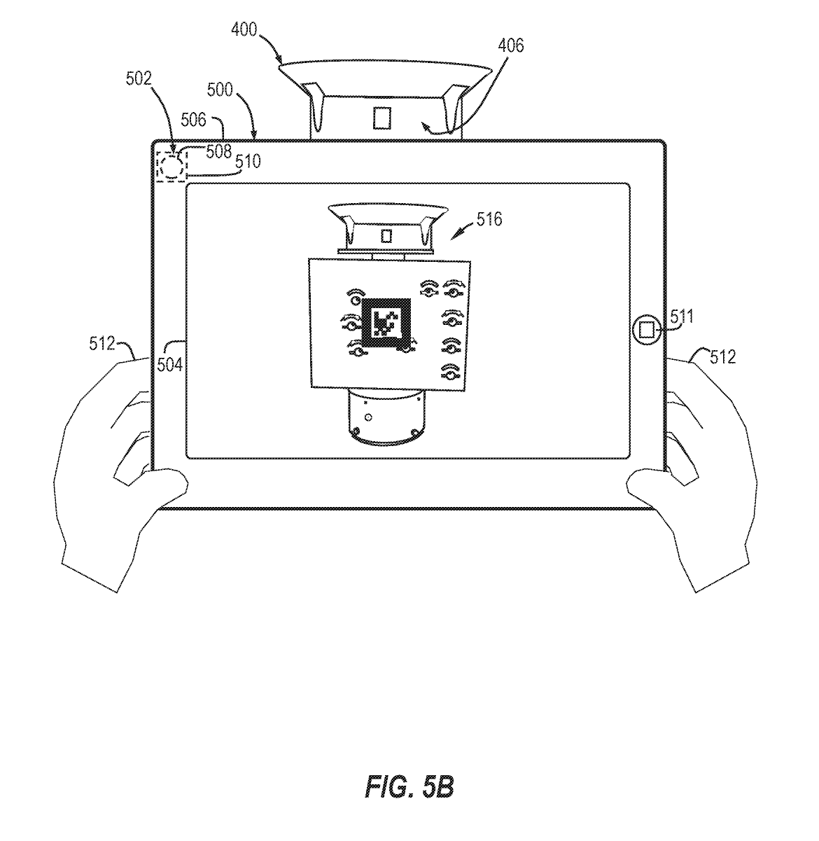

FIG. 5A is a representation of one type of mobile device 500 that includes an image sensor to generate an image, in combination with a partial perspective view of the first side 402 of the subsea equipment 400, in accordance with some embodiments.

Referring to FIG. 5A, in accordance with some embodiments, the mobile device 500 includes a camera 502, a display 504 and a case 506, which supports the camera 502 and the display 504. The camera includes an aperture 508 and an image sensor 510.

The mobile device 500 further includes an on/off button and/or other type of control 511 that can be activated and/or otherwise used by a user to turn the mobile device 500 on and off.

The user 512 has positioned the mobile device 500 such that the image sensor 510 is directed toward the first side 402 of the subsea equipment 400. In some embodiments, the positioning may be such that the image sensor 510 has a perspective of the first side 402 of the subsea equipment 400 that is the same as, and/or similar to, a perspective that the user 512 has of the first side 402 of the subsea equipment 400. With such positioning, an image 514 of the first side 402 (and/or any other portion of the subsea equipment) may be from a perspective that is the same as, and/or similar to, a perspective that the user 512 has of the first side 402 (and/or any other portion of the subsea equipment).

The display is shown displaying an image 514 (of the first side 402) that has been generated by the image sensor 510. However, there is no requirement for the display 504 to display such image 514.

FIG. 5B is a representation of the mobile device 500 in combination with a partial perspective view of the second side 406 of the subsea equipment 400, in accordance with some embodiments.

Referring to FIG. 5B, in accordance with some embodiments, the user 512 has positioned the mobile device 500 such that the image sensor 510 directed towards the second side 406 of the subsea equipment 400. In some embodiments, the positioning may be such that the image sensor 510 has a perspective of the second side 406 of the subsea equipment 400 that is the same as, and/or similar to, a perspective that the user 512 has of the second side 406 of the subsea equipment 400. With such positioning, an image 516 of the second side 406 (and/or any other portion of the subsea equipment) may be from perspective that is the same as, and/or similar to, a perspective that the user 512 has of the second side 406 (and/or any other portion of the subsea equipment).

The display is shown displaying an image 516 (of the second side 406) that has been generated by the image sensor 510. However, there is no requirement for the display 504 to display such image 514.

Referring again to FIGS. 3A-3C, at 306, the method may further include identifying the subsea equipment that is located in a topside environment.

The identifying of the subsea equipment may be performed in any manner.

In some embodiments, the identifying of the subsea equipment may be performed by a processor in the mobile device that includes the image sensor 510 and/or by a processor in any other mobile device. In some embodiments, the identifying of the subsea equipment may be performed by a processor in the processing system 150 and/or by a processor in other portions of the system 100.

In some embodiments, the identifying of the subsea equipment may be based at least in part on the image captured by the image sensor 510.

In some embodiments, the identifying of the subsea equipment may comprise identifying one or more features in the image of the subsea equipment that is located in a topside environment; and identifying the subsea equipment based at least in part on the one or more features.

In some embodiments, a mapping may be used.

As used herein, a “mapping” may have any form.

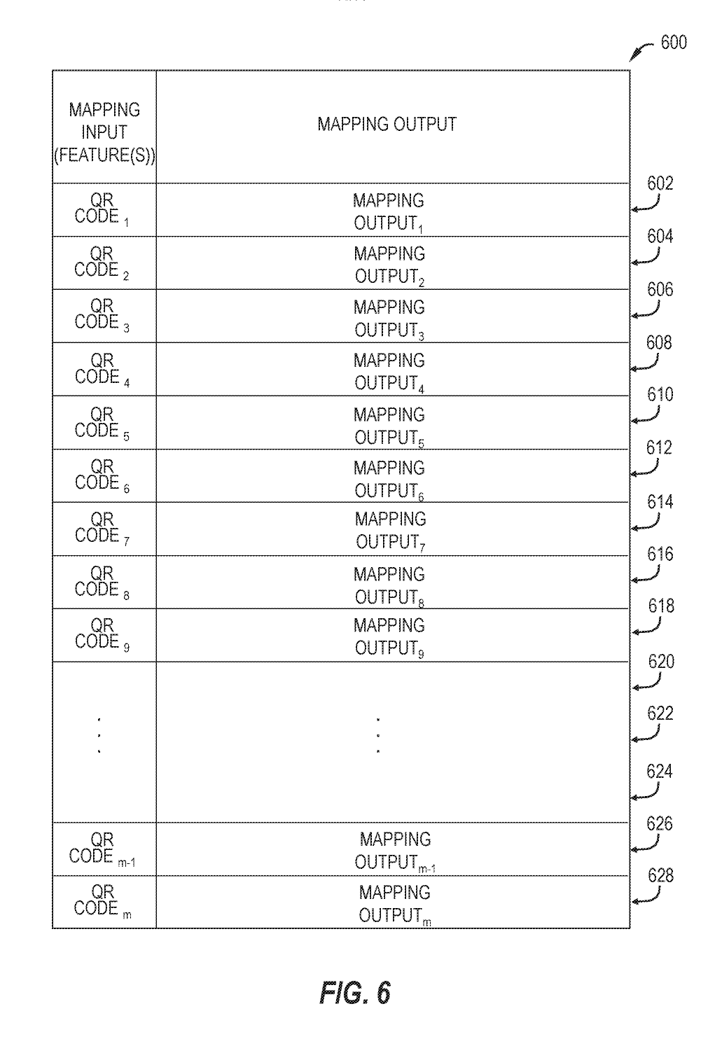

FIG. 6 is a graphical representation of one type of mapping 600, in accordance with some embodiments.

Referring to FIG. 6, in accordance with some embodiments, the mapping 600 may comprise a look-up table having a plurality of input/output combinations, e.g., input/output combinations 602-628. Each input/output combination may be associated with particular subsea equipment (a particular piece of subsea equipment and/or a particular type of subsea equipment). In some embodiments, the input for a given combination may include one or more features that may be identifiable in an image of the subsea equipment with which the given input/output combination is associated. The output for a given combination may include information that identifies the particular subsea equipment with which the given input/output combination is associated.

For example, a first entry 602, may map a first QR code (e.g., QR code 404 in FIG. 4A) to a first mapping output that may include information that identifies subsea equipment that includes the first QR code (e.g., the first side 402 of subsea equipment 400 in FIG. 4A and/or subsea equipment 400 in general).

A second entry 604, may map a second QR code (e.g., QR code 408 in FIG. 4B) to a second mapping output that may include information that identifies subsea equipment that includes the second QR code (e.g., the second side 406 of subsea equipment 400 in FIG. 4B and/or subsea equipment 400 in general).

In some embodiments, the output for a given input/output combination may identify program code that is associated with the subsea equipment and may include information that identifies the subsea equipment with which the given input/output combination is associated.

In some embodiments, the program code may guide a user through inspection (or portion(s) thereof) of one or more portions of the subsea equipment that are to be inspected while the subsea equipment is located in a topside environment.

In some embodiments, such program code may be in the form of hypertext markup language (HTML) and/or any other form.

As used herein, a program may include but is not limited to machine readable code.

As used herein, “code” may include, but is not limited to, instructions in a high level language, low level language, machine language and/or other type of language or combination thereof.

Referring again to FIGS. 3A-3C, at 308, the method may further include determining a representation of the subsea equipment that is located in a topside environment and one or more portions of the subsea equipment that are to be inspected while the subsea equipment is located in a topside environment.

As used herein, the term “representation” means any type of representation.

A representation may or may not be an exact representation of the subsea equipment.

In some embodiments, the representation of the subsea equipment may comprise a three dimensional model and/or other type of model of the subsea equipment. A three dimensional model may comprise a CAD (computer aided design) model and/or any other type of three dimensional model.

In some embodiments, the representation of the subsea equipment may comprise an image generated by the image sensor 510. In some embodiments, a representation may not comprise an image generated by an image sensor, but may be based at least in part on an image generated by an image sensor.

In some embodiments, a representation of subsea equipment may represent less than all subsea equipment in an image and/or in a topside environment. In some embodiments, a representation of subsea equipment may include one or more features that are not present in the subsea equipment represented by the representation.

In some embodiments, one or more portions of a representation may have a degree of opacity and/or transparency (and/or coloring) that is different than a degree of an opacity and/or transparency (and/or coloring) of the one or more portions of the subsea equipment that the one or more portions of the representation represent. In some embodiments, a representation may have different degrees of opacity and/or transparency and/or may have one or more portions highlighted to indicate information that may be relevant to an operation that is to be performed.

In some embodiments, providing a representation in which one or more portions have a degree of transparency and/or coloring may further assist a user in locating one or more portions of subsea equipment that are to be inspected.

As stated above, in some embodiments, a representation that is from a perspective that is the same as, and/or similar to, a perspective that a user (field service engineer or other person) has of the subsea equipment may further assist the user in locating one or more portions of the subsea equipment that are to be inspected (and/or in one or more other activities associated with the subsea equipment).

With that in mind, in some embodiments, it may be advantageous for the representation of the subsea equipment to be from a perspective that is the same as, and/or similar to, a perspective that a user has of the subsea equipment.

In some embodiments, this may be achieved (to at least some degree) by providing a representation that is from a same, and/or similar, perspective as the image generated by the image sensor. As stated above, in some embodiments, the user will have positioned the mobile device such that the image sensor has a perspective of the subsea equipment that is the same as, and/or similar to, a perspective that the user has of the subsea equipment. The image generated by the image sensor may then be from a perspective of the subsea equipment that is the same as and/or similar to a perspective that the field service engineer (and/or other person) has of the subsea equipment.

In some embodiments, the perspectives may be the same and/or similar in one or more but not all dimensions. In some embodiments, the perspectives may not be the same in a vertical dimension (Z axis). In some embodiments, the perspectives may not be the same in a horizontal dimension (X axis or Y axis).

As used herein, the term “inspect” means inspect in any manner and/or degree. In some embodiments, the term “inspect” may comprise look at, look over, examine and/or check.

As used herein, the phrase “to be inspected” means to be inspected to for any reason(s). In some embodiments, the reason(s) may be to complete one or more options, suggestions and/or requirements in one or more specification(s) and/or other document(s) (of any type). In some embodiments, the one or more specification(s) and/or other document(s) may be generated and/or otherwise provided by one or more entities (one or more company, government, and/or other entity). The one or more specification(s) and/or other document(s) may have any form(s). In some embodiments, one or more of the specification(s) and/or other document(s) may be in the form of program code.

In some embodiments, different portions of subsea equipment may have different portions to be inspected.

The determining of a representation of the subsea equipment and one or more portions that are to be inspected may be performed in any manner.

In some embodiments, the determining (or portion(s) thereof) may be performed by a processor in the mobile device that includes the image sensor 510 and/or by a processor a mobile device that includes a display. In some embodiments, the determinations (or portion(s) thereof) may be performed by a processor in one or more portions of the processing system 150 and/or by a processor in one or more other portions of the system 100.

In some embodiments, the determining of a representation of the subsea equipment and one or more portions that are to be inspected may be based at least in part on the image generated by the image sensor 510.

In some embodiments, the determining of a representation of the subsea equipment and one or more portions of the subsea equipment that are to be inspected may comprise: identifying one or more features in the image of the subsea equipment that is located in a topside environment; and determining, based at least in part on the one or more feature identified in the image of the subsea equipment, a representation of the subsea equipment and one or more portions of the subsea equipment that are to be inspected while the subsea equipment is located in a topside environment.

In some embodiments, one or more portions of the above may be performed using a mapping. In some embodiments, the mapping may comprise the mapping 600 (FIG. 6).

As stated above, the mapping 600 may comprise a look-up table having a plurality of input/output combinations, e.g., input/output combinations 602-628. In some embodiments, the input for a given combination may include one or more features that may be identifiable in an image of the subsea equipment with which the given input/output combination is associated. The output for a given combination may include information that identifies a representation of the subsea equipment with which the given input/output combination is associated and/or information that identifies one or more portions of such subsea equipment that are to be inspected while such subsea equipment is located in a topside environment.

For example, the first entry 602, may map the first QR code (e.g., QR code 404 in FIG. 4A) to a first mapping output that may include information that identifies a representation of subsea equipment that includes the first QR code (e.g., the first side 402 of subsea equipment 400 in FIG. 4A and/or subsea equipment 400 in general) and/or information that identifies one or more portions of subsea equipment (that includes the first QR code) and are to be inspected (e.g., one or more of portions 402A-402M in FIG. 4A) while such subsea equipment is located in a topside environment.

The second entry 604, may map the second QR code (e.g., QR code 408 in FIG. 4B) to a second mapping output that may include information that identifies a representation of subsea equipment that includes the second QR code (e.g., the second side 406 of subsea equipment 400 in FIG. 4B and/or subsea equipment 400 in general) and/or information that identifies one or more portions of subsea equipment (that includes the first QR code) and are to be inspected (e.g., one or more of portions 406A-406K in FIG. 4B) while such subsea equipment is located in a topside environment.

In some embodiments, the output for a given input/output combination identifies program code that includes information that identifies a representation of the subsea equipment with which the given input/output combination is associated and/or information that identifies one or more portions of the subsea equipment that are to be inspected while such subsea equipment is located in a topside environment.

In some embodiments, the program code may guide a user through inspection (or portion(s) thereof) of one or more portions of the subsea equipment that are to be inspected while the subsea equipment is located in a topside environment.

In some embodiments, such program code may be in the form of hypertext markup language (HTML) and/or any other form.

Referring again to FIGS. 3A-3C, at 310, the method may further include displaying, by a display of a mobile device, a view that includes: (i) a representation of the subsea equipment that is located in a topside environment and (ii) an indicator that shows or designates portion of the representation that includes a representation of one or more portions of the subsea equipment that are to be inspected while the subsea equipment is located in a topside environment.

As used herein, the term “indicator” means any type of indicator.

In some embodiments, an indicator may comprise a graphical indicator.

In some embodiments, the indicator may comprise an arrow, a circle (and/or any other type of indicator that surrounds at least a portion of the representation that includes a representation of one or more portions of the subsea equipment that are to be inspected while the subsea equipment is located in a topside environment) and/or coloring or any other type of highlighting.

FIG. 7 is a representation of one type of mobile device 500 that includes a display 504, in combination with a partial perspective view of the first side 402 of the subsea equipment 400, in accordance with some embodiments.

Referring to FIG. 7, the display 504 is shown displaying a view 700. In accordance with embodiments, the view 700 (and/or any other view disclosed herein) may be a view in a graphical user interface that may be provided by the mobile device 500 (and/or other mobile device).

In accordance with some embodiments, the view 700 may include: (i) a representation 702 of the subsea equipment that is located in a topside environment and (ii) an indicator 704 that indicates a portion of the representation that includes a representation of one or more portions of the subsea equipment that are to be inspected while the subsea equipment is located in a topside environment.

As stated above, a representation of the subsea equipment may comprise any type of representation of the subsea equipment. In some embodiments, the representation 702 may comprise a three dimensional model of the subsea equipment. In some embodiments, the representation may comprise and/or may be based at least in part on the image generated by the image sensor.

The representation 702 that is shown in the view 700 is one embodiment of a representation that is from a perspective that is the same as, and/or similar to, a perspective that the user has of the subsea equipment 400. In some embodiments, the representation 702 that is shown in the view 700 may be one that is displayed if the image sensor 510 generated the image 514 (FIG. 5A). In some embodiments, the representation 702 that is shown in the view 700 may also be one that is displayed if the image sensor 510 generated a different image that included the QR code 404 (FIG. 4A) and/or one or more others of the one or more features that may be used in identifying the first side 402 of the subsea equipment 400.

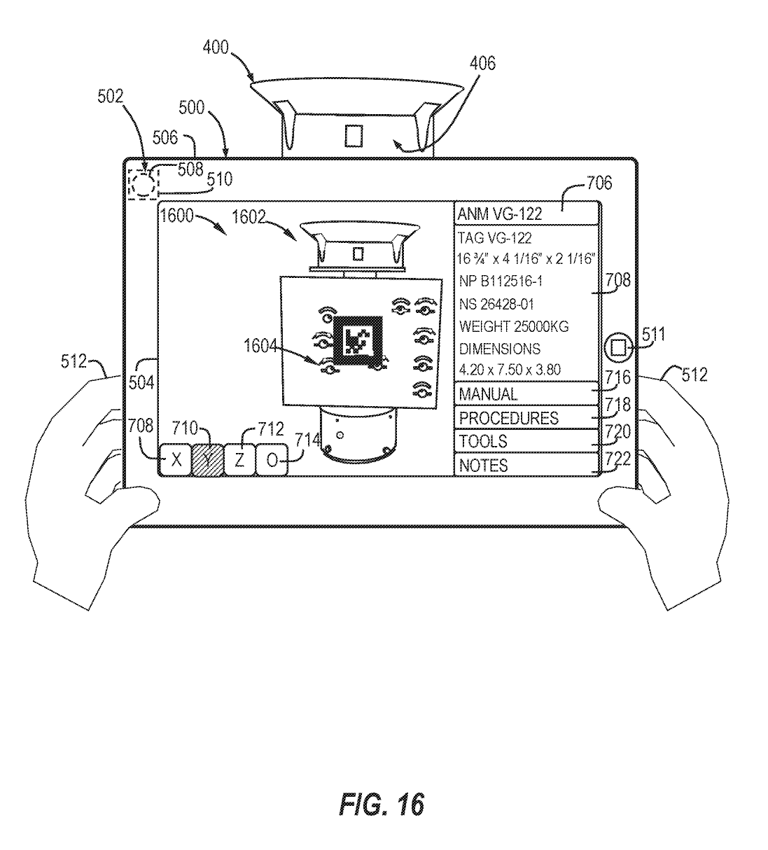

However, as will be further described below with respect to FIG. 16, in some embodiments, a different representation may be displayed. In some embodiments, a different representation may be displayed if the image sensor 510 generated the image 516 (FIG. 5B) and/or a different image that included the QR code 408 (FIG. 4B) (and/or one or more others of the one or more features that may be used in identifying the second side 406 of the subsea equipment 400).

In some embodiments, the view 700 may further include information 706 that identifies the subsea equipment that is located in a topside environment. In the illustrated embodiment, the information 706 identifies the subsea equipment as “ANM VG-122”. In some embodiments, the view 700 may further include information 708 that may identity a tag (e.g., VG-122), a part number (e.g., B112516-1), a serial number (e.g., 26428-01), a weight (e.g., 25000 kg) and/or dimensions (e.g., 16¾ inches×4 1/16 inches×2 1/16 inches or 4.20×7.50×3.80) associated with the subsea equipment 400.

In the illustrated embodiment, the mobile device 500 includes the display 504 and the image sensor 510. However, as stated above, the mobile device that displays the view may or may not be the mobile device that includes the image sensor that generates the image of the subsea equipment. In some embodiments, the mobile device that includes the display may be coupled (directly and/or indirectly) to the mobile device that includes the image sensor.

The indicator 704 is shown as an arrow that points to a portion of the representation 702 that includes a representation of one or more portions (e.g., portion 402C in FIG. 4A) of the subsea equipment that are to be inspected while the subsea equipment is located in a topside environment.

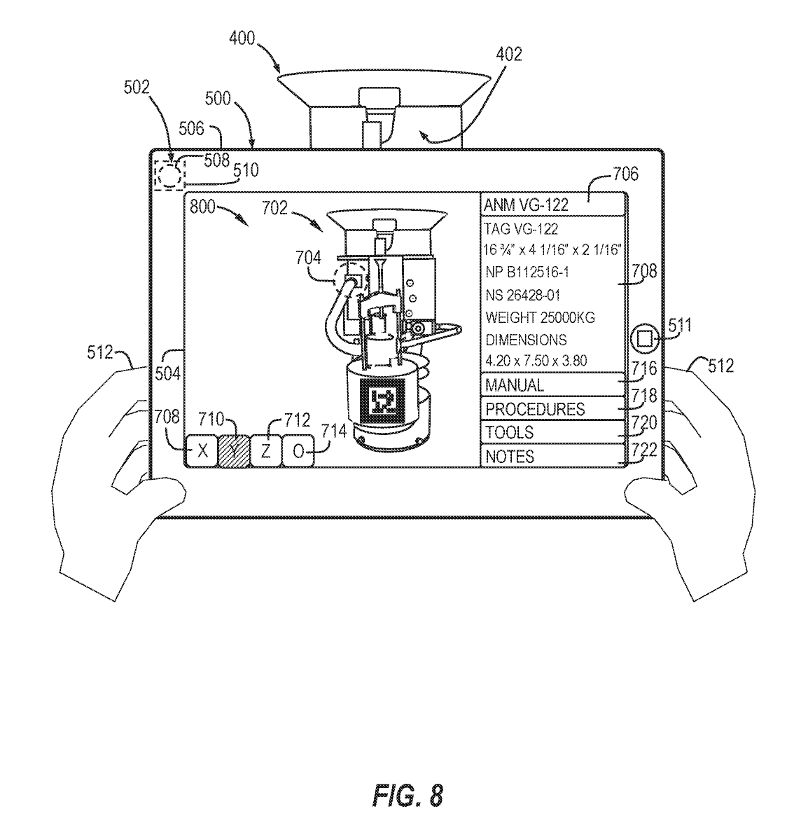

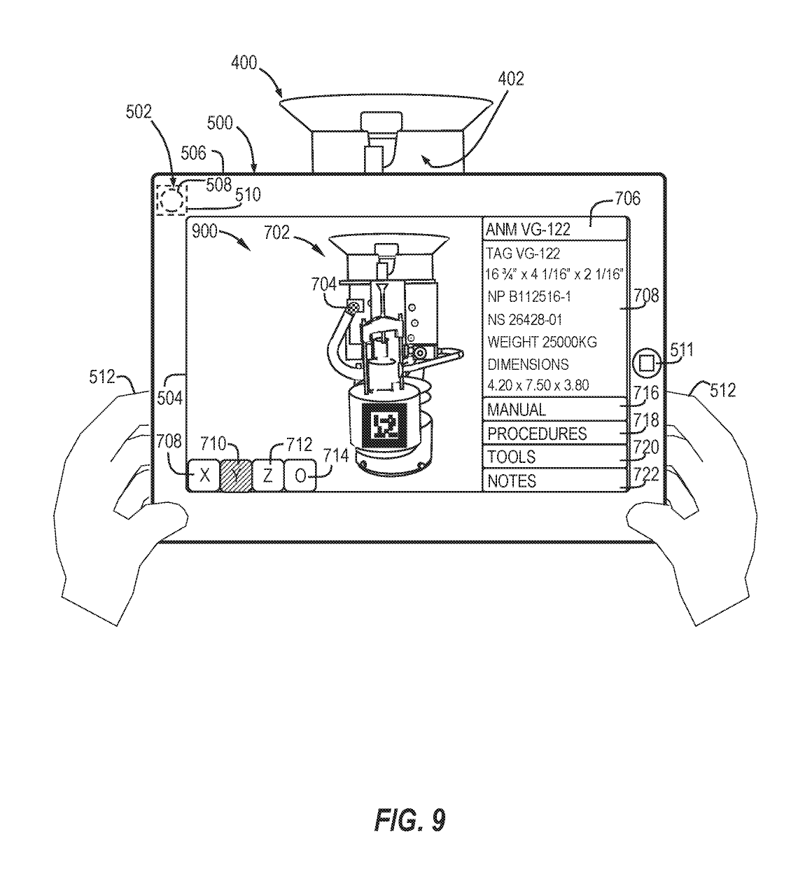

However, in some embodiments, the indicator may not be an arrow that points to a portion of the representation 702. As stated above, and as will be further discussed below with respect to FIG. 8 and FIG. 9, in some embodiments, the indicator 704 may comprise a circle (and/or any other type of indicator that surrounds at least a portion of the representation that includes a representation of one or more portions (e.g., portion 402C in FIG. 4A) of the subsea equipment that are to be inspected while the subsea equipment is located in a topside environment) and/or coloring or any other type of highlighting.

FIG. 8 is a representation of the mobile device 500, in combination with a partial perspective view of the first side 402 of the subsea equipment 400, in accordance with some embodiments.

Referring to FIG. 8, the display 504 of the mobile device 500 is shown displaying a view 800, in accordance with some embodiments. In accordance with some embodiments, the view 800 is similar to the view 700 (FIG. 7) except that the indicator 704 in the view 800 comprises a circle that surrounds a portion of the representation that includes a representation of one or more portions (e.g., portion 402C in FIG. 4A) of the subsea equipment that are to be inspected while the subsea equipment is located in a topside environment.

FIG. 9 is a representation of the mobile device 500, in combination with a partial perspective view of the first side 402 of the subsea equipment 400, in accordance with some embodiments.

Referring to FIG. 9, the display 504 of the mobile device 500 is shown displaying a view 900, in accordance with some embodiments. In accordance with some embodiments, the view 900 is similar to the view 700 (FIG. 7) except that the indicator 704 in the view 900 comprises coloring to highlight a portion of the representation that includes a representation of one or more portions (e.g., portion 402C in FIG. 4A) of the subsea equipment that are to be inspected while the subsea equipment is located in a topside environment.

Referring again to FIGS. 3A-3C, at 312, the method may further include receiving a request from a user to modify a characteristic of the representation of the subsea equipment.

The receiving may be performed in any manner.

In some embodiments, the receiving may be performed by a processor in the mobile device that includes the image sensor 510 and/or by a processor a mobile device that includes a display. In some embodiments, the receiving (or portion(s) thereof) may be performed by a processor in one or more portions of the processing system 150 and/or by a processor in one or more other portions of the system 100.

In some embodiments, the request may comprise a request to zoom, rotate, modify an opacity (and/or transparency) and/or modify a color of one or more portions of representation.

As further discussed below, an ability to request a modification to a characteristic of the representation of the subsea equipment may further assist a user in locating one or more portions of the subsea equipment that area to be inspected (and/or in one or more other activities associated with the subsea equipment).

At 314, the method may further include determining a second representation of the subsea equipment that is located in a topside environment based at least in part on the request from the user to modify a characteristic of the representation.

At 316, the method may further include displaying, by a display of a mobile device, a second view that includes: (i) the second representation of the subsea equipment that is located in a topside environment and (ii) an indicator that indicates a portion of the second representation that includes a representation of one or more portions of the subsea equipment that are to be inspected while the subsea equipment is located in a topside environment.

The request to modify a characteristic of the representation may be received in any manner.

In some embodiments, the request may be received via user interaction with a user interface. In some embodiments, the interaction may comprise use of one or more finger gestures.

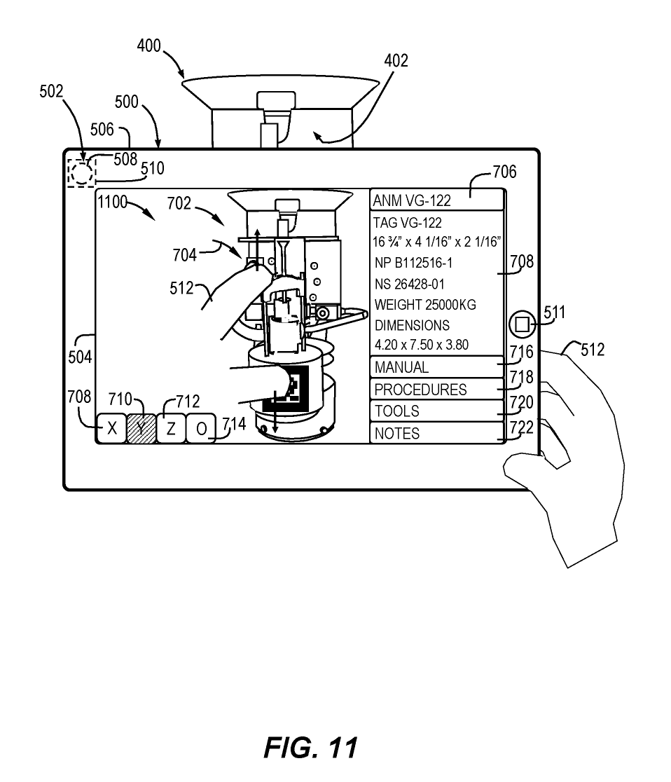

As further described below with respect to FIG. 10 and FIG. 11, in some embodiments, a pinch gesture may represent a request to zoom out. A reverse pinch gesture may represent a request to zoom in.

FIG. 10 is a representation of the mobile device 500, in combination with a partial perspective view of the first side 402 of the subsea equipment 400, in accordance with some embodiments.

Referring to FIG. 10, the display 504 of the mobile device 500 is shown displaying a view 1000, in accordance with some embodiments. In accordance with some embodiments, the view 1000 is similar to the view 700 (FIG. 7) except that the representation 702 in the view 1000 has been reduced in size (compared the size of the representation 702 in FIG. 7) in response to a pinch gesture that represents a request to zoom out.

FIG. 11 is a representation of the mobile device 500, in combination with a partial perspective view of the first side 402 of the subsea equipment 400, in accordance with some embodiments.

Referring to FIG. 11, the display 504 of the mobile device 500 is shown displaying a view 1100, in accordance with some embodiments. In accordance with some embodiments, the view 1100 is similar to the view 700 (FIG. 7) except that the representation 702 in the view 1100 has been increased in size (compared the size of the representation 702 in FIG. 7) in response to a reverse pinch gesture that represents a request to zoom in.

In some embodiments, an interaction to request a modification to one or more characteristics of the representation may comprise use of one or more graphical tools.

As further described below with respect to FIG. 7, in some embodiments, one or more graphical tools may be used to specify an axis about which the user may desire to have the representation 702 rotated, to at least some degree.

Referring again now to FIG. 7, the view 700 may include graphical tools 708-712, which may be activated by a user (e.g., via a user interaction or selection of an option) to specify an axis about which the user may desire to have the representation 702 rotated, to at least some degree. For example, the graphical tool 708 may be activated to specify the x-axis as the axis about which the user may desire to have the representation 702 rotated, to at least some degree. The graphical tool 710 may be activated to specify the y-axis as the axis. The graphical tool 712 may be activated to specify the z-axis as the axis. The graphical tool 714 may be activated to disable rotation (until re-enabled by activation of one of graphical tools 708-712).

In the illustrated embodiment, the graphical tool 710 has been activated to specify the y-axis as the axis about which the user may desire to have the representation 702 rotated, to at least some degree.

In some embodiments, after an axis has been specified, a rotation about the specified axis may be requested.

In some embodiments, one or more types of finger gesture may represent a request to rotate the representation 702 about the specified axis, to at least some degree.

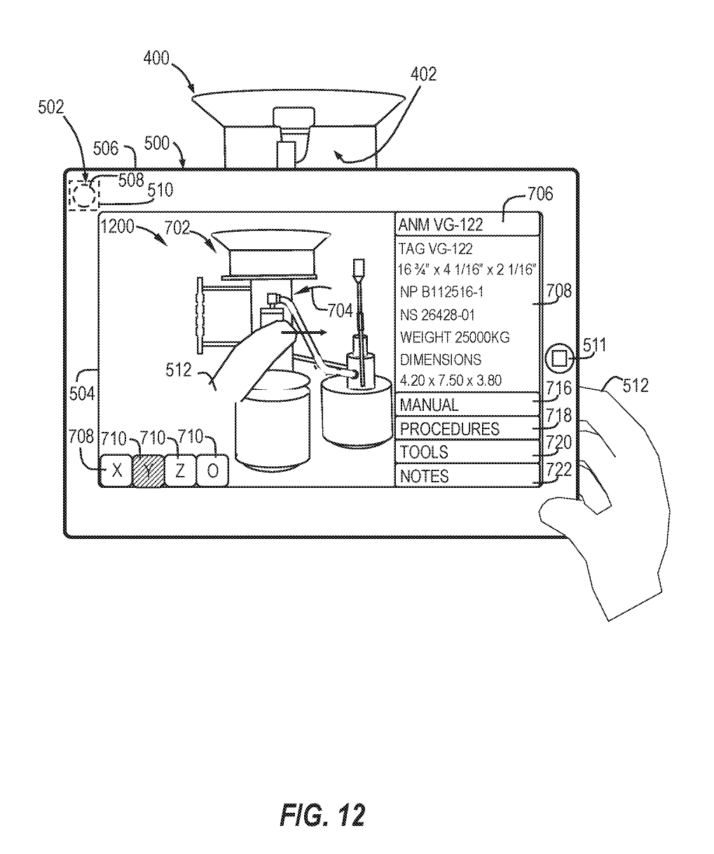

As further described below with respect to FIG. 12, in some embodiments, a swipe type of finger gesture may represent the request.

FIG. 12 is a representation of the mobile device 500, in combination with a partial perspective view of the first side 402 of the subsea equipment 400, in accordance with some embodiments.

Referring to FIG. 12, the display 504 of the mobile device 500 is shown displaying a view 1200, in accordance with some embodiments. In accordance with some embodiments, the view is similar to the view 700 (FIG. 7) except that the representation 702 of the subsea equipment in the view 1200 has been rotated, to at least some degree, in response to a swipe gesture that represents a request to rotate about the specified axis, to at least some degree.

In some embodiments, multiple swipe gestures may be used to increase and/or decrease the amount of rotation.

As shown in FIG. 12, in some embodiments, the rotation may result in a representation that is from a perspective that is significantly different from a perspective that the user has of the subsea equipment.

However, the result in any given situation will depend on the rotation, the perspective of the representation prior to the rotation, and the perspective of the user.

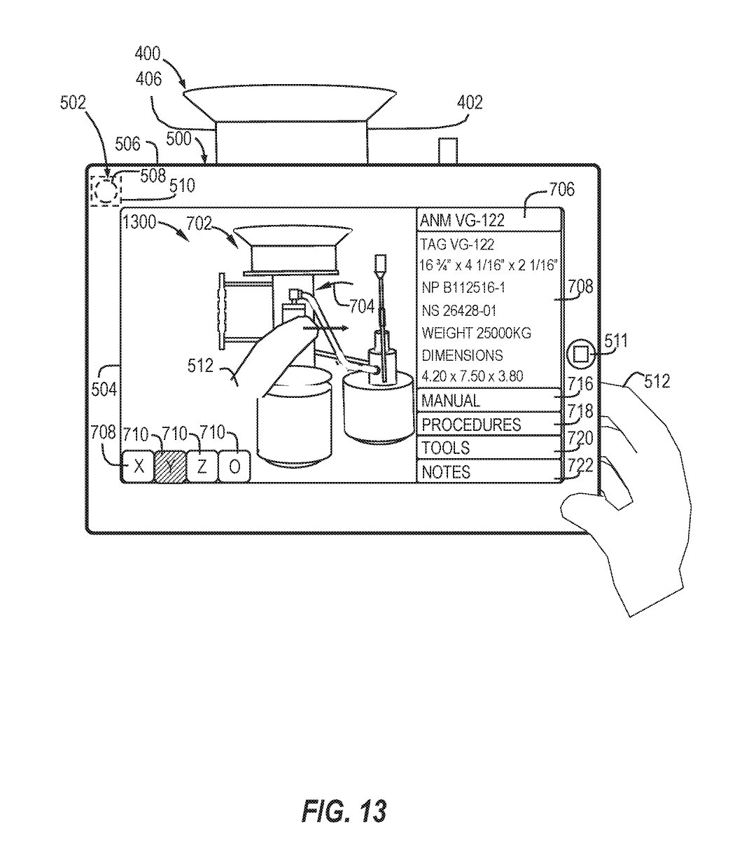

As further described below with respect to FIG. 13, in some embodiments, a rotation may result in a representation that is from a perspective that is the same as, and/or similar to, a perspective that the user has of the subsea equipment.

FIG. 13 is a representation of the mobile device 500, in combination with a partial perspective view of the first side 402 of the subsea equipment 400, in accordance with some embodiments.

Referring to FIG. 13, the display 504 of the mobile device 500 is shown displaying a view 1300, in accordance with some embodiments. In accordance with some embodiments, the view is similar to the view 1200 (FIG. 12). However, in FIG. 13, the user has a different perspective of the subsea equipment and the rotation has resulted in a representation that is from a perspective that is the same as, and/or similar to, the perspective that the user has of the subsea equipment.

As stated above, in some embodiments, a representation that is from a perspective that is the same as and/or similar to, a perspective that the user (field service engineer or other person) has of the subsea equipment may further assist the user in locating one or more portions of the subsea equipment that area to be inspected (and/or in one or more other activities associated with the subsea equipment).

As also stated above, and as further discussed below with respect to FIG. 14 and FIG. 15, in some embodiments, the request to modify a characteristic of the representation 702 may comprise a request to modify an opacity (and/or transparency) and/or a color of one or more portions of the representation.

FIG. 14 is a representation of the mobile device 500, in combination with a partial perspective view of the first side 402 of the subsea equipment 400, in accordance with some embodiments.

Referring to FIG. 14, the display 504 of the mobile device 500 is shown displaying a view 1400, in accordance with some embodiments. In accordance with some embodiments, the view 1400 is similar to the view 700 (FIG. 7) except that the representation 702 in the view 1400 has one or more portions (shown in dashed outline) that are shown partially transparent in response to a request to modify an opacity and/or transparency of the one or more portions of the representation.

FIG. 15 is a representation of the mobile device 500, in combination with a partial perspective view of the first side 402 of the subsea equipment 400, in accordance with some embodiments.

Referring to FIG. 15, the display 504 of the mobile device 500 is shown displaying a view 1500, in accordance with some embodiments. In accordance with some embodiments, the view 1500 is similar to the view 700 (FIG. 7) except that the representation 702 in the view 1500 has one or more portions that are omitted and/or fully transparent in response to a request to modify an opacity and/or transparency of the one or more portions of the representation.

As stated above with respect to FIG. 7, in some embodiments, the representation 702 shown in the view 700 may be one that is displayed if the image sensor 510 generated the image 514 (FIG. 5A). In some embodiments, the representation 702 shown in the view 700 may also be one that is displayed if the image sensor 510 generated a different image that included the QR code 404 (FIG. 4A) and/or one or more others of the one or more features that may be used in identifying the first side 402 of the subsea equipment 400.

However, as will be further described below with respect to FIG. 16, in some embodiments, a different representation may be displayed. In some embodiments, a different representation may be displayed if the image sensor 510 generated the image 516 (FIG. 5B) and/or a different image that included the QR code 408 (FIG. 4B) (and/or one or more others of the one or more features that may be used in identifying the second side 406 of the subsea equipment 400).

FIG. 16 is a representation of the mobile device 500 that includes the display 504, in combination with a partial perspective view of the second side 406 of the subsea equipment 400, in accordance with some embodiments.

Referring to FIG. 16, the display 504 of the mobile device 500 is shown displaying a view 1600, in accordance with some embodiments. In accordance with some embodiments, the view 1600 may include: (i) a representation 1602 of the subsea equipment that is located in a topside environment and (ii) an indicator 1604 that indicates a portion of the representation that includes a representation of one or more portions of the subsea equipment that are to be inspected while the subsea equipment is located in a topside environment.

The representation 1602 that is shown in the view 1600 is one embodiment of a representation that is from a perspective that is the same as, and/or similar to, a perspective that the user has of the subsea equipment 400. In some embodiments, the representation 1602 that is shown in the view 1600 may be one that is displayed if the image sensor 510 generated the image 516 (FIG. 5B). In some embodiments, the representation 1602 that is shown in the view 700 may also be one that is displayed if the image sensor 510 generated a different image that included the QR code 408 (FIG. 4B) and/or one or more others of the one or more features that may be used in identifying the second side 406 of the subsea equipment 400.

The indicator 1604 is shown as an arrow that points to a portion of the representation 1602 that includes a representation of one or more portions (e.g., portion 406F in FIG. 4B) of the subsea equipment that are to be inspected while the subsea equipment is located in a topside environment.

However, in some embodiments, the indicator may not be an arrow that points to a portion of the representation 1602. As stated above, in some embodiments, the indicator 1604 may comprise a circle (and/or any other type of indicator that surrounds at least a portion of the representation that includes a representation of one or more portions (e.g., portion 406F in FIG. 4B) of the subsea equipment that are to be inspected while the subsea equipment is located in a topside environment) and/or coloring or any other type of highlighting.

In some embodiments, the user may have moved after the first image is generated, and after moving, the user may have a different perspective of the subsea equipment than the user had of the subsea equipment before to moving.

As stated above, in some embodiments, it may be advantageous for the representation of the subsea equipment to be from a perspective that is the same as, and/or similar to, a perspective that a user has of the subsea equipment.

As stated above, in some embodiments, this may be achieved (to at least some degree) by generating an image and displaying a representation that is from a same and/or similar perspective as the image.

To that effect, referring again to FIGS. 3A-3C, at 318, the method may further include generating, by an image sensor of a mobile device, a second image of the subsea equipment that is located in a topside environment.

As with the first image, the second image (and/or any other image) may be generated in any manner.

In some embodiments, the second image may be generated at the request of a user with an expectation that generating a new image would result in displaying of a new view.

At 320, the method may further include determining a third representation of the subsea equipment that is located in a topside environment based at least in part on the second image of the subsea equipment that is located in a topside environment.

At 322, the method may further include displaying, by a display of a mobile device, a third view that includes: (i) the third representation of the subsea equipment that is located in a topside environment and (ii) an indicator that indicates a portion of the representation that includes a representation of one or more portions of the subsea equipment that are to be inspected while the subsea equipment is located in a topside environment.

In some embodiments, the third representation will be from a perspective that is the same as, and/or similar to, a perspective that a user has of the subsea equipment.

As stated above, in some embodiments, the second image may be generated at the request of a user with an expectation that generating a new image would result in displaying of a new view.

At 324, the method may further include receiving a request from a user for instructions in regard to performing an inspection of one or more portions of the subsea equipment that are to be inspected while the subsea equipment is located in a topside environment.

The request for instructions may have any form and may be received in any manner.

In some embodiments, the request may be received via user interaction with a user interface.

In some embodiments, a request for instructions may have the form of a selection of a procedure for which instructions are desired.

As further described below with respect to FIG. 17, in some embodiments, one or more graphical tools may be used by a user to request instructions in regard to performing an inspection of one or more portions of the subsea equipment that are to be inspected while the subsea equipment is located in a topside environment.

Referring first again to FIG. 7, in some embodiments, the view 700 may include a graphical tool 718, which may be activated by a user (e.g., via a user interaction or selection of an option) to cause the mobile device 500 to provide an interface that lists procedures in an inspection process for the subsea equipment.

FIG. 17 is a representation of the mobile device 500 displaying a view 1700 of an interface that lists procedures in an inspection process for the subsea equipment, in accordance with some embodiments. In some embodiments, the interface may allow a user to select one or more of the procedures for which instructions are desired and may guide a user through each selected procedure.

Referring to FIG. 17, in accordance with some embodiments, the view 1700 may include a plurality of graphical tools 1702-1720.

The graphical tool 1702 may be activated by a user to cause the interface to list previous procedures in an inspection process for the subsea equipment.

The graphical tools 1704-1716 may each be activated by a user to select a respective procedure for which instructions are desired, in accordance with some embodiments. For example, the graphical tool 1704 may be activated by a user to select a procedure (procedure 7.1) for which instructions are desired, in accordance with some embodiments.

At 326, the method may further include displaying, by a display of a mobile device, a fourth view that includes: (i) a representation of the subsea equipment that is located in a topside environment and (ii) instructions in regard to inspection of one or more of the one or more portions of the subsea equipment that are to be inspected while the subsea equipment is located in a topside environment.

The instructions may be determined in any manner.

In some embodiments, the instructions may be determined, at least in part, in a manner similar to determination of the representation

In some embodiments, the instructions may be determined, based at least in part, on a mapping between subsea equipment and instructions associated with topside inspection of the subsea equipment.

In some embodiments, the mapping, or portion(s) thereof, may be in the form of a program for inspection of subsea equipment.

The instructions may be any type of instructions.

In some embodiments, the one or more instructions may include an instruction that instructs the user, to check one or more portions of one or more valves on the subsea equipment. In some embodiments, the one or more questions may include a question that relates to a check of one or more portions of one or more valves on the subsea equipment. In some embodiments, the status information may indicate a current step of the inspection and/or other status of the inspection.

FIG. 18 is a representation of the mobile device 500, in combination with a partial perspective view of the first side 402 of the subsea equipment 400 that may be located in a topside environment, in accordance with some embodiments.

Referring to FIG. 18, the display 504 of the mobile device 500 is shown displaying a view 1800, in accordance with some embodiments.

In accordance with some embodiments, the view 1800 may include: (i) a representation 1802 of the subsea equipment that is located in a topside environment and (ii) instructions 1806 in regard to inspection of one or more of the one or more portions of the subsea equipment that are to be inspected while the subsea equipment is located in a topside environment.

As stated above, a representation of the subsea equipment may comprise any type of representation of the subsea equipment. In some embodiments, a representation may have different degrees of opacity and/or transparency and/or may have one or more portions highlighted to indicate information that is relevant to an operation that is to be performed.

In some embodiments, the view may further include an indicator 1804 that indicates a portion of the representation that includes a representation of one or more portions of the subsea equipment that are to be inspected while the subsea equipment is located in a topside environment.

The instructions 1806 may comprise any type of instruction(s). In the illustrated embodiment, the instructions 1806 instruct the user to “Inspect components overall state, replacing all needed seal: VX/VGX ring of the subsea tree”.

In some embodiments, the view 1800 may further include status information 1808. In the illustrated embodiment, the status information 1808 indicates that the current portion of the inspection is procedure “7.1”.

In some embodiments, the view 1800 (and/or any one or more other views) may further include one or more graphical tools that may be activated by a user (e.g., via a user interaction or selection of an option).

In some embodiments, one or more of the graphical tools may include graphical tools 1810-1820 to further assist a user in regard to inspecting (and/or any other activity associated with) the subsea equipment that is located in a topside environment.

The graphical tool 1810 may be activated by a user to cause the inspection process to return to a prior procedure in the process.

The graphical tool 1812 may be activated by a user to indicate that the procedure has been performed. In some embodiments, such indication causes the inspection process to advance to a next procedure in the process.

The graphical tool 1814 may be activated by a user to cause the inspection process to skip to a next procedure in the inspection process.

The graphical tool 1816 may be activated by a user to cause the mobile device 500 to provide an interface that allows a user to input notes, capture and/or input pictures and/or provide other information.

FIG. 19 is a representation of the mobile device 500 displaying a view 1900 of an interface that allows a user to input notes, capture and/or input pictures and/or provide other information, in accordance with some embodiments.

In some embodiments, the view 1900 may include a plurality of graphical tools 1902-1908. The graphical tool 1902 may define a touch pad that may be used by a user to input text (representing notes or other information) into a text box 1904. The graphical tool 1906 may be activated by a user to cause the mobile device 500 to capture and/or input a picture. The graphical tool 1908 may be activated by a user to associate the notes, pictures and/or other information with an operation and/or step in an inspection process.

In some embodiments, the interface may provide a user with the ability to log and/or otherwise create a record of findings (of any anomalies and/or other findings) during an inspection, rather than after an inspection.

In some embodiments, the ability to log and/or otherwise create a record of procedures that are performed during an inspection, rather than after an inspection, may increase compliance and thereby increase safety.

Referring again to FIG. 18, the graphical tool 1818 may be activated by a user to cause the mobile device 500 to provide an interface that allows a user to create and/or edit a plumbing table. In some embodiments, the interface may include a configurable table from which a user may create a plumbing table that shows results of tests performed during a deployment and/or other point(s) in time.

FIG. 20 is a representation of the mobile device 500 displaying a view provided by an interface that allows a user to create and/or edit a plumbing table, in accordance with some embodiments.

Referring again to FIG. 18, the graphical tool 1820 may be activated by a user to cause the mobile device to provide an interface that allows a user to access one or more hydraulic diagrams.

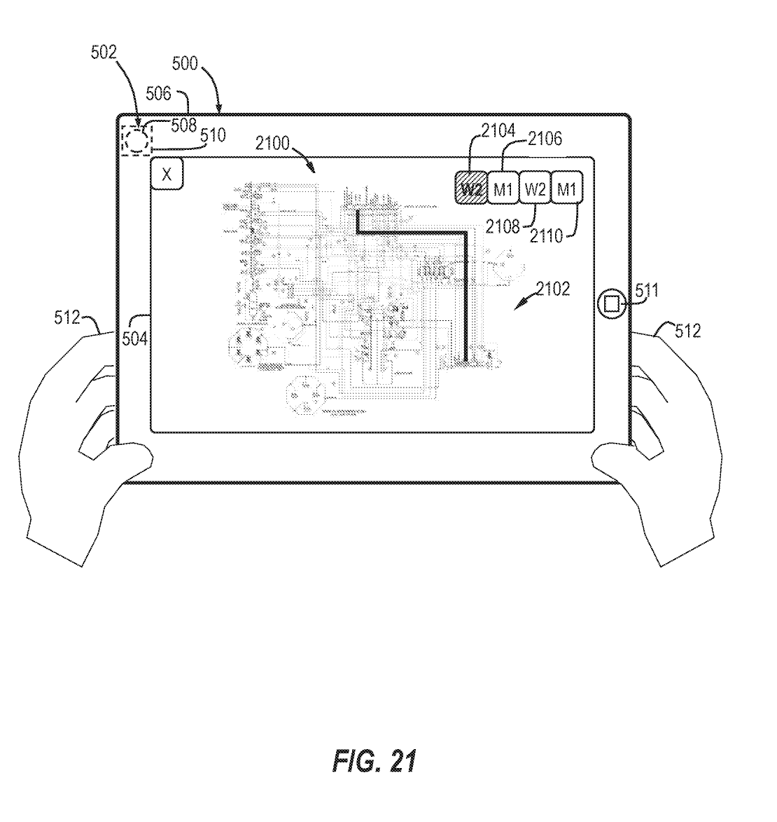

FIG. 21 is a representation of the mobile device 500 displaying a view 2100 provided by an interface that allows a user to access one or more hydraulic diagrams, in accordance with some embodiments.

Referring to FIG. 21, the view 2100 may include a hydraulic diagram 2102 and may further includes graphical tools 2104-2110 that may be activated by a user to cause the interface to highlight one or more of the lines in the hydraulic diagram to help the user find and/or follow such line(s) in the hydraulic diagram.

In the illustrated embodiment, activation of the graphical tool 2104 causes highlighting of a hydraulic line referred to as “W2”. Activation of the graphical tool 2106 causes highlighting of a hydraulic line referred to as “M1”. Activation of the graphical tool 2108 causes highlighting of a hydraulic line referred to as “W2”. Activation of the graphical tool 2110 causes highlighting of a hydraulic line referred to as “M1”. In some embodiments, each line that is highlighted may be highlighted in a different color than the others so as to distinguish the highlighted lines. The graphical tool 2104 is shown activated and the line referred to as “W2” is shown highlighted.

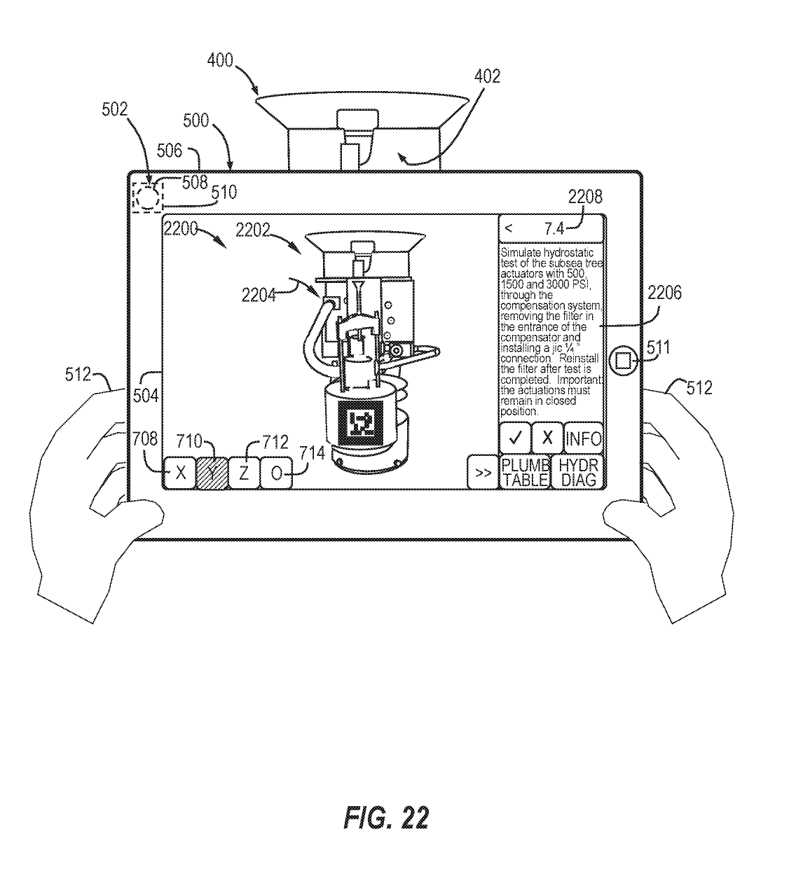

FIG. 22 is a representation of the mobile device 500, in combination with a partial perspective view of the first side 402 of the subsea equipment 400 that may be located in a topside environment, in accordance with some embodiments.

Referring to FIG. 22, the display 504 of the mobile device 500 is shown displaying another view 2200 that includes: (i) a representation 2202 of the subsea equipment that is located in a topside environment and (ii) instructions 2206 in regard to inspection of one or more of the one or more portions of the subsea equipment that are to be inspected while the subsea equipment is located in a topside environment, in accordance with some embodiments.

In some embodiments, the view 2200 may further include an indicator 2204 that indicates a portion of the representation that includes a representation of one or more portions of the subsea equipment that are to be inspected while the subsea equipment is located in a topside environment.

The instructions 2206 may comprise any type of instruction(s). In the illustrated embodiment, the instructions 2206 instruct the user to ““Simulate hydrostatic test of the subsea tree actuators with 500, 1500 and 3000 PSI, through the compensation system, removing the filter in the entrance of the compensator and installing a jic ¼” connection. Reinstall the filter after test is completed. Important: the actuations must remain in closed position.”

In some embodiments, the view 2200 may further include status information 2208. In the illustrated embodiment, the status information 2208 indicates that the current portion of the inspection is procedure “7.4”.

FIG. 23 is a representation of the mobile device 500, in combination with a partial perspective view of the second side 406 of the subsea equipment 400 that may be located in a topside environment, in accordance with some embodiments.

Referring to FIG. 23, the display 504 of the mobile device 500 is shown displaying another view 2300 that includes: (i) a representation 2302 of the subsea equipment that is located in a topside environment and (ii) instructions 2306 in regard to inspection of one or more of the one or more portions of the subsea equipment that are to be inspected while the subsea equipment is located in a topside environment, in accordance with some embodiments.

In some embodiments, the view 2300 may further include an indicator 2304 that indicates a portion of the representation that includes a representation of one or more portions of the subsea equipment that are to be inspected while the subsea equipment is located in a topside environment.

The instructions 2306 may comprise any type of instruction(s). In the illustrated embodiment, the instructions 2306 instruct the user to “Check the override of all valves of the subsea tree” and asks the user to “Confirm the override check” for “IQ1 valve”.

In some embodiments, the view 2300 may further include status information 2308. In the illustrated embodiment, the status information 2308 indicates that the current portion of the inspection is procedure “7.10”.

Referring again to FIG. 7, in some embodiments, the view 700 (and/or any one or more other views) may further include one or more graphical tools 716, 720-722, which may be activated by a user (e.g., via a user interaction or selection of an option).

In some embodiments, the graphical tool 716 may be activated by a user to cause the mobile device 500 to provide an interface that allows the user to access (and navigate) an electronic manual (sometimes referred to herein as a tool manual) that provides information about tools that may be used in inspecting and/or other activity associated with the subsea equipment that is located in a topside environment.

FIG. 24 is a representation of the mobile device 500 displaying a view 2400 of an interface that allows the user to access (and navigate) the tool manual, in accordance with some embodiments.

Referring again to FIG. 7, the graphical tool 720 may be activated by a user to cause the mobile device 500 to provide an interface that allows a user to access pictures of tools that may be used in association with the subsea equipment and/or inspection thereof.

FIG. 25 is a representation of the mobile device 500 displaying a view 2500 of an interface that allows a user to access pictures of tools 2502 that may be used in association with the subsea equipment and/or inspection thereof, in accordance with some embodiments.

Referring again to FIG. 7, the graphical tool 722 may be activated by a user to cause the mobile device 500 to provide an interface that allows a user to input notes, capture and/or input pictures and/or provide other information. In some embodiments, the interface may provide a view that is the same as, and/or similar to, the view 1900 (FIG. 19).

Referring again to FIGS. 3A-3C, at 328, the method may further include receiving information in regard to a result of an inspection of one or more of the one or more portions of the subsea equipment that are to be inspected while the subsea equipment is located in a topside environment.

The information in regard to the results may be any type(s) of information from any source(s).

In some embodiments, the information may be received from the user via a graphical user interface and/or any other input device(s).

In some embodiments, the information in regard to the results may comprise information that a field service engineer and/or other person has input to a plumbing table.

At 330, the method may further include displaying, by a display of a mobile device, a fifth view that includes: (i) a representation of the subsea equipment that is located in a topside environment and (ii) an indicator that indicates the result of the inspection of the one or more of the one or more portions of the subsea equipment that are to be inspected while the subsea equipment is located in a topside environment.

The indicator may comprise any type of indicator.

FIG. 26 is a representation of the mobile device 500, in combination with a partial perspective view of the second side 406 of the subsea equipment 400 that may be located in a topside environment, in accordance with some embodiments.

Referring to FIG. 18, the display 504 of the mobile device 500 is shown displaying a view 2600, in accordance with some embodiments. In accordance with some embodiments, the view 1800 may include: (i) a representation 2602 of the subsea equipment that is located in a topside environment and (ii) an indicator 2306 that indicates the result of the inspection of the one or more of the one or more portions of the subsea equipment that are to be inspected while the subsea equipment is located in a topside environment.

In the illustrated embodiment, the indicator 2306 may indicate that a valve has passed all checks. In the illustrated embodiment, the indicator comprises coloring. One or more colors (e.g., blue) may indicate a “pass” (represented schematically by horizontal lines). One or more other colors (e.g., red) may indicate “incomplete” and/or “fail” (represented schematically by vertical lines.

In the illustrated embodiment, a plurality of indicators are used, one for each valve being inspected in the subsea equipment. Each indicator in the view may be positioned on and/or proximate to, a representation of the valve with which the indicator is associated.

In some embodiments, each indicators may be set to indicate ““incomplete”, not pass and/or “fail”” until the inspection of the associated valve is complete and the valve passes.

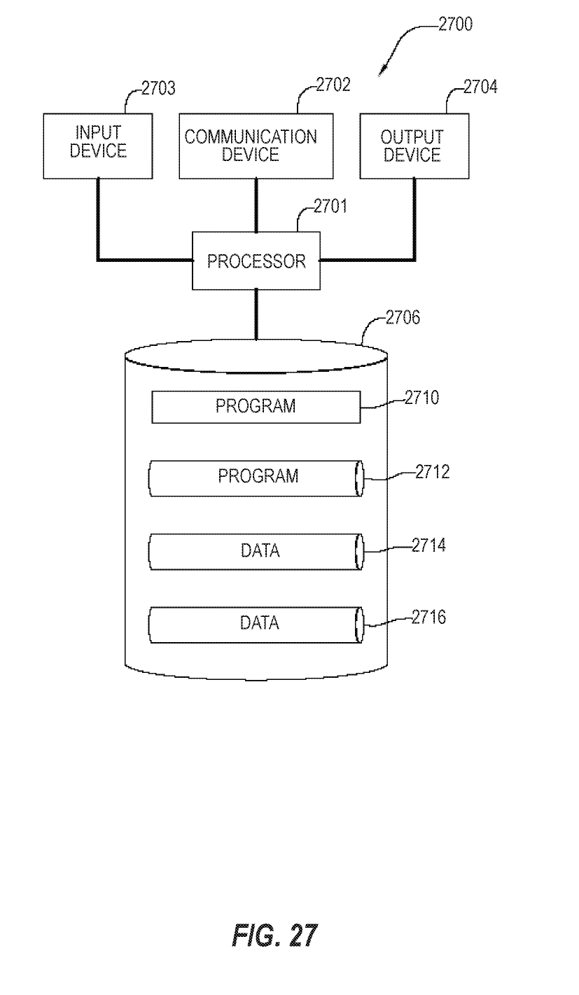

FIG. 27 is a block diagram of an architecture 2700 according to some embodiments. In some embodiments, one or more of the systems (or portion(s) thereof) and/or devices (or portion(s) thereof) disclosed herein may have an architecture that is the same as and/or similar to one or more portions of the architecture 2700.

In some embodiments, one or more of the methods (or portion(s) thereof) disclosed herein may be performed by a system, apparatus and/or device having an architecture that is the same as or similar to the architecture 2700 (or portion(s) thereof).

The architecture may be implemented as a distributed architecture or a non-distributed architecture. A distributed architecture may be a completely distributed architecture or a partly distributed-partly non distributed architecture.

Referring to FIG. 27, in accordance with some embodiments, the architecture 2700 includes a processor 2701 operatively coupled to a communication device 2702, an input device 2703, an output device 2704 and a storage device 2706, each of which may be distributed or non-distributed.

In some embodiments, the processor 2701 may execute processor-executable program code to provide one or more portions of the one or more disclosed herein and/or to carry out one or more portions of one or more embodiments of one or more methods disclosed herein.

In some embodiments, the processor 2701 may include one or more microprocessors, such as, for example, one or more “general-purpose” microprocessors, one or more special-purpose microprocessors and/or application specific integrated circuits (ASICS), or some combination thereof. In some embodiments, the processor 2701 may include one or more reduced instruction set (RISC) processors.

The communication device 2702 may be used to facilitate communication with other devices and/or systems. In some embodiments, communication device 2702 may be configured with hardware suitable to physically interface with one or more external devices and/or network connections. For example, communication device 2702 may comprise an Ethernet connection to a local area network through which architecture 2700 may receive and transmit information over the Internet and/or one or more other network(s).

The input device 2703 may comprise, for example, one or more devices used to input data and/or other information, such as, for example: a keyboard, a keypad, track ball, touchpad, a mouse or other pointing device, a microphone, knob or a switch, an infra-red (IR) port, etc. The output device 2704 may comprise, for example, one or more devices used to output data and/or other information, such as, for example: an IR port, a display, a speaker, and/or a printer, etc.

In some embodiments, the input device 2703 and/or output device 2704 define a user interface, which may enable an operator to input data and/or other information and/or to view output data and/or other information.

The storage device 2706 may comprise, for example, one or more storage devices, such as, for example, magnetic storage devices (e.g., magnetic tape and hard disk drives), optical storage devices, and/or semiconductor memory devices such as Random Access Memory (RAM) devices and Read Only Memory (ROM) devices.

The storage device 2706 may store one or more programs 2710-2712 and/or other information for operation of the architecture 2700. In some embodiments, the one or more programs 2710-2712 include one or more instructions to be executed by the processor 2701 to provide one or more portions of one or more tasks and/or one or more portions of one or more methods disclosed herein. In some embodiments, the one or more programs 2710-2712 include one or more operating systems, database management systems, other applications, other information files, etc., for operation of the architecture 2700.

The storage device 2706 may store one or more databases and/or other information 2714-2716 for one or more programs. As used herein a “database” may refer to one or more related or unrelated databases. Data and/or other information may be stored in any form. In some embodiments, data and/or other information may be stored in raw, excerpted, summarized and/or analyzed form.

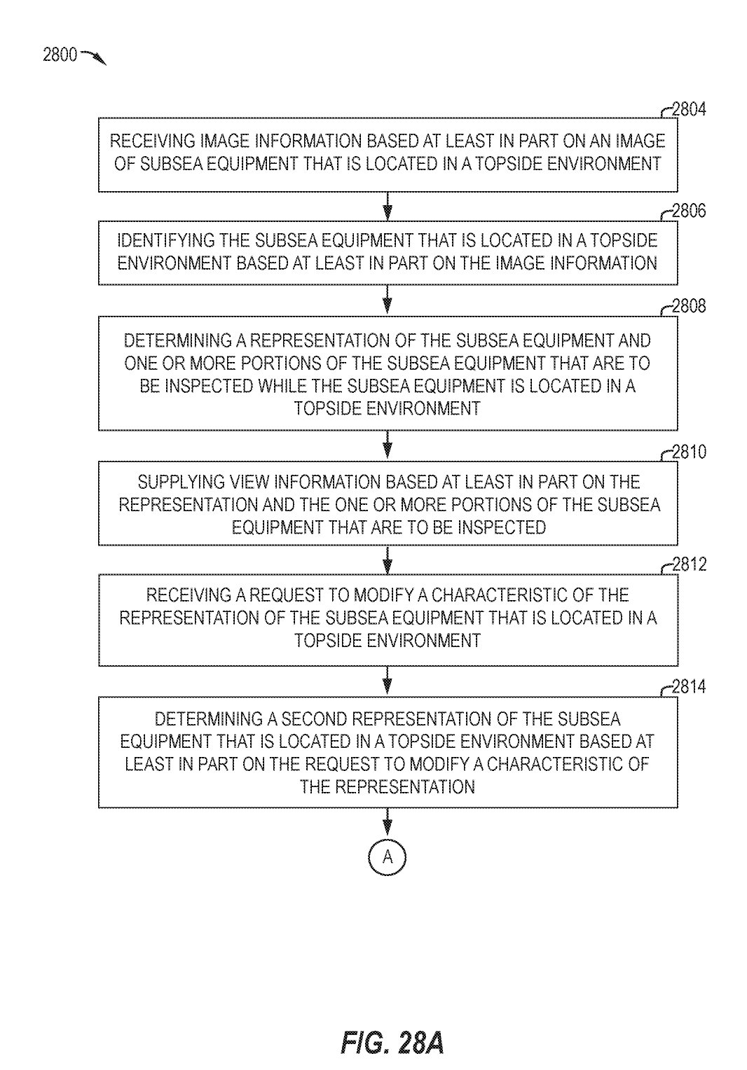

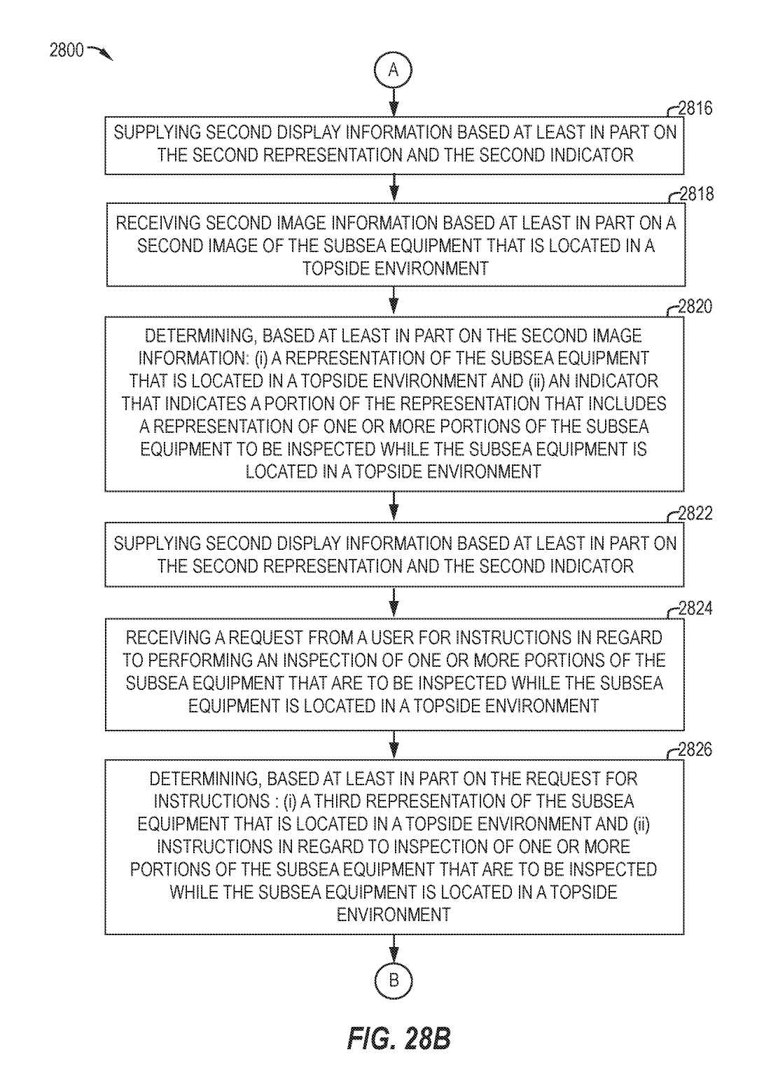

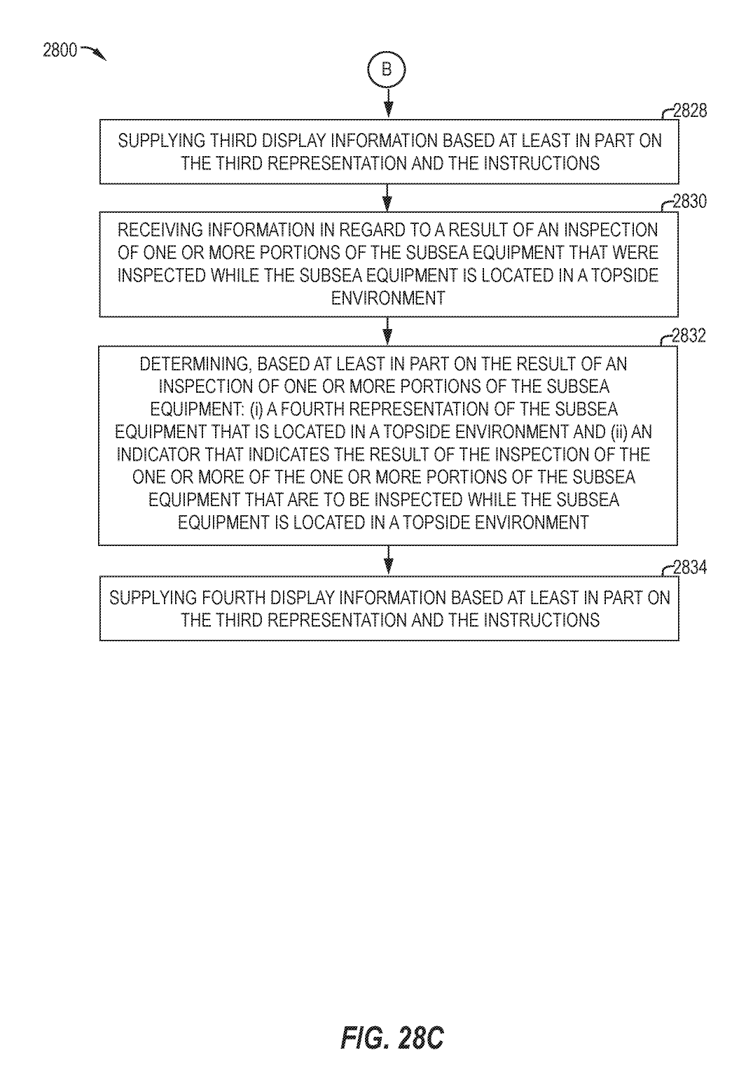

FIGS. 28A-28C are a flow chart of a method 2800, in accordance with some embodiments.

In some embodiments, one or more portions of the method may be performed by a processor in carrying out one or more portions of the method 300 (FIGS. 3A-3C).

In some embodiments, the method is performed by a processor in the mobile device that includes the image sensor, a processor in the mobile device that includes the display and/or a processor in one or more other portion(s) of the system 100.

In some embodiments, one or more portions of the method 2800 may be performed without one or more other portions of the method 2800.

Referring to FIGS. 28A-28C, in accordance with some embodiments, at 2804, the method may include receiving image information that is based at least in part on an image of subsea equipment that is located in a topside environment.

The image information may have any form and may be received in any manner, from any source(s), directly and/or indirectly, external and/or internal.

In some embodiments, the image may comprise the image generated at 304 (FIGS. 3A-3C).

In some embodiments, the image information may comprise the image generated at 304 (FIGS. 3A-3C).

At 2806, the method may further include identifying the subsea equipment that is located in a topside environment based at least in part on the image information.

In some embodiments, the identifying of the subsea equipment may comprise identifying one or more feature in the image information; and identifying the subsea equipment that is located in a topside environment based at least in part on the one or more feature identified in the image information.

In some embodiments, a mapping may be used.

At 2808, the method may further include determining, by the processor, a representation of the subsea equipment that is located in a topside environment and one or more portions of the subsea equipment that are to be inspected while the subsea equipment is located in a topside environment, based at least in part on the image information.

In some embodiments, the determining of the representation and/or the one or more portions of the subsea equipment that are to be inspected may be performed in a manner that is the same as and/or similar one or more embodiments described above for determining a representation of subsea equipment and/or one or more portions of the subsea equipment that are to be inspected at 308 of the method 300 (FIGS. 3A-3C).

Thus, in some embodiments, the determining may comprise identifying one or more feature in the image information; and determining, based at least in part on the one or more feature identified in the image information: (i) a representation of the subsea equipment that is located in a topside environment and (ii) one or more portions of the subsea equipment that are to be inspected while the subsea equipment is located in a topside environment.

In some embodiments, the representation may comprise the representation determined at 310 of the method 300 (FIGS. 3A-3C).

In some embodiments, the one or more portions of the subsea equipment that are to be inspected while the subsea equipment is located in a topside environment may comprise the one or more portions of the subsea equipment that are to be inspected while the subsea equipment is located in a topside environment determined at 310 of the method 300 (FIGS. 3A-3C).

At 2810, the method may further include supplying, by the processor, view information that is based at least in part on the representation and the one or more portions of the subsea equipment that are to be inspected while the subsea equipment is located in a topside environment.

View information may have any form and may be supplied in any manner, to any device or other receiver of information, directly and/or indirectly, external and/or internal.

In some embodiments, the view information may include information based up on which, at least in part, the view displayed by a display of a mobile device at 310 of the method 300 (FIGS. 3A-3C) is generated.

In some embodiments, the view information may comprise the view itself.

In some embodiments, the view information may be supplied, directly and/or indirectly, to the mobile device that includes the display and is located in a topside environment.

In some embodiments, such mobile device may further include the processor and the processor may supply the view information to the display and/or one or more other portions of such mobile device.

In some embodiments, the processor may be external to such mobile device and the processor may transmit the view information to the mobile device, directly and/or indirectly.

At 2812, the method may further include receiving, by the processor, a request to modify a characteristic of the representation of the subsea equipment. A request may have any form and may be received in any manner, from any source(s), directly and/or indirectly, external and/or internal.

In some embodiments, the request to modify a characteristic of the representation of the subsea equipment may be based at least in part on the request received from a user at 312 of the method 300 (FIGS. 3A-3C). In some embodiments, the request to modify a characteristic of the representation of the subsea equipment may comprise the request (received from the user) itself.

In some embodiments, the request may be supplied, directly and/or indirectly, from the mobile device that includes the display and is located in a topside environment.

At 2814, the method may further include determining, by the processor, based at least in part on the request to modify a characteristic of the representation: (i) a second representation of the subsea equipment that is located in a topside environment and (ii) a second indicator that indicates a portion of the second representation that includes a representation of one or more portions of the subsea equipment that are to be inspected while the subsea equipment is located in a topside environment.

In some embodiments, the second representation may comprise the second representation determined at 314 of the method 300 (FIGS. 3A-3C).

At 2816, the method may further include supplying, by the processor, view information based at least in part on the second representation and the second indicator.

In some embodiments, the view information may include information based up on which, at least in part, the view displayed by a display of a mobile device at 316 of the method 300 (FIGS. 3A-3C) is generated.

In some embodiments, the view information may comprise the view itself.

In some embodiments, the view information may be supplied, directly and/or indirectly, to the mobile device that includes the display and is located in a topside environment.

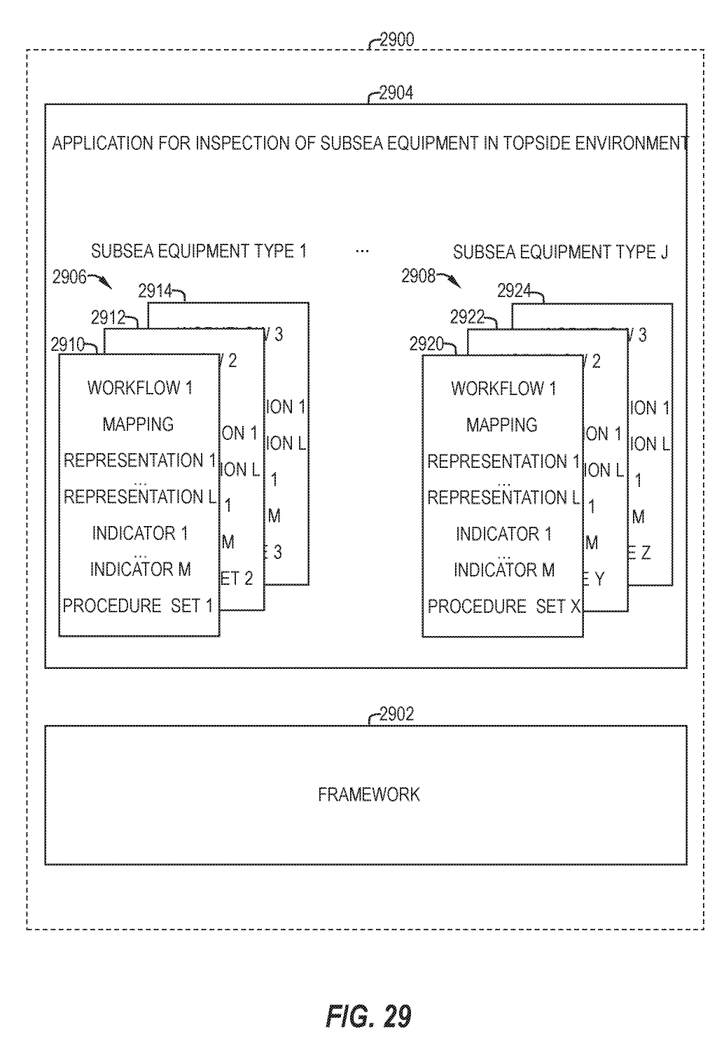

FIG. 29 is a representation of a software architecture 2900, in accordance with some embodiments.

Referring to FIG. 29, in accordance with some embodiments, a software architecture may include a framework for creating applications for industrial environments 2902 and an application for inspecting subsea equipment in a topside environment 2904 that is built on the framework 2902.

In some embodiments, the application for subsea equipment 2904 may include a plurality of program sets, e.g., programs sets 2906-2908, each of which may be associated with a respective one of a plurality of types of subsea equipment, e.g., subsea equipment type 1-subsea equipment type J.

Each program set may include a plurality of programs. For example, program set 2906 may include programs 2910-2914. Program set 2908 may include programs 2920-2924. Each of the plurality of programs may define a different workflow for the type of subsea equipment associated therewith. For example, a first program 2910 associated with subsea equipment type 1 may define workflow 1. A second program 2912 associated with subsea equipment type 1 may define workflow 2. A third program 2914 associated with subsea equipment type 1 may define workflow 3.

In some embodiments, each workflow may be associated with a different type of operation and may include a different set of procedures. For example, in some embodiments, workflow 1 for subsea equipment type 1 may be associated with installation of subsea equipment type 1 and may include procedure set 1. Workflow 2 for subsea equipment type 2 may be associated with workover of subsea equipment type 1 and may include procedure set 2. Workflow 3 for subsea equipment type 3 may be associated with removal of subsea equipment type 1 and may include procedure set 3.

In some embodiments, the set of procedures to be performed in any given workflow are predefined by a specification.

In some embodiments, each workflow may further include one or more representation of the subsea equipment, one or more indicator that indicates a portion of a representation that includes a representation of one or more portions of the subsea equipment that are to be inspected, and a mapping.

A program may have any form. In some embodiments, the programs are in the form of hypertext markup language (HTML) and/or any other form(s).

In some embodiments, one or more portions of one or more embodiments disclosed herein may be embodied in a method, an apparatus, a system, a computer program product, and/or a non-transitory machine readable storage medium with instructions stored thereon. As used herein, a machine may be any type of machine. In some embodiments, a machine comprises a processor.

Unless stated otherwise, a processor may comprise any type of processor. For example, a processor may be programmable or non-programmable, general purpose or special purpose, dedicated or non-dedicated, distributed or non-distributed, shared or not shared, and/or any combination thereof. A processor may include, but is not limited to, hardware, software (e.g., low level language code, high language code, microcode), firmware, and/or any combination thereof. Hardware may include, but is not limited to off the shelf integrated circuits, custom integrated circuits and/or any combination thereof. In some embodiments, a processor comprises a microprocessor. Software may include, but is not limited to, instructions that are storable and/or stored on a computer readable medium, such as, for example, magnetic or optical disk, magnetic or optical tape, CD-ROM, DVD, RAM, EPROM, ROM or other semiconductor memory. A processor may employ continuous signals, periodically sampled signals, and/or any combination thereof. If a processor is distributed, two or more portions of the processor may communicate with one another through a communication link.

Unless stated otherwise, the term “processor” should be understood to include one processor or two or more cooperating processors.

Unless stated otherwise, the term “memory” should be understood to encompass a single memory or storage device or two or more memories or storage devices.

Unless stated otherwise, a processing system is any type of system that includes at least one processor.

Unless stated otherwise, a “communication link” may comprise any type(s) of communication link(s), for example, but not limited to, wired links (e.g., conductors, fiber optic cables) or wireless links (e.g., acoustic links, microwave links, satellite links, infrared links or other electromagnetic links) or any combination thereof, each of which may be public and/or private, dedicated and/or shared. Information may be of any type and in any form, for example, but not limited to, analog and/or digital in serial and/or in parallel form. Information may or may not be divided into blocks. A communication link may employ a protocol or combination of protocols including, for example, but not limited to the Internet Protocol.

Unless otherwise stated, information may include data and/or any other type of information.

Unless otherwise stated, terms such as, for example, “in response to” and “based on” mean “in response at least to” and “based at least on”, respectively, so as not to preclude being responsive to and/or based on, more than one thing.

Unless stated otherwise, terms such as, for example, “comprises”, “has”, “includes”, and all forms thereof, are considered open-ended, so as not to preclude additional elements and/or features. In addition, unless stated otherwise, terms such as, for example, “a”, “one”, “first”, are considered open-ended, and do not mean “only a”, “only one” and “only a first”, respectively. Moreover, unless stated otherwise, the term “first” does not, by itself, require that there also be a “second”.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. Apparatus comprising:
a mobile device having an image sensor to capture an image of subsea equipment that is located in a topside environment; and
a mobile device having a display to display a view that includes: (i) a representation of the subsea equipment that is located in a topside environment and (ii) an indicator that indicates a portion of the representation that includes a representation of one or more portions of the subsea equipment that are to be inspected while the subsea equipment is located in a topside environment.

2. The apparatus of claim 1, wherein the indicator draws attention to a portion of the representation that includes a representation of one or more portions of the subsea equipment that are to be inspected while the subsea equipment is located in a topside environment.

3. The apparatus of claim 1, wherein the image of the subsea equipment that is located in a topside environment is from a perspective; and
wherein the display a view that includes: (i) a representation of the subsea equipment that is located in a topside environment and (ii) an indicator that indicates a portion of the representation that includes a representation of one or more portions of the subsea equipment that are to be inspected while the subsea equipment is located in a topside environment comprises:
display a view that includes: (i) a representation of the subsea equipment from a perspective that is the same as the perspective of the image of the subsea equipment that is located in a topside environment and (ii) an indicator that indicates a portion of the representation that includes a representation of one or more portions of the subsea equipment that are to be inspected while the subsea equipment is located in a topside environment.

4. The apparatus of claim 1, further comprising a processor to:
determine, based at least in part on the image of the subsea equipment that is located in a topside environment, one or more of the one or more portions of the subsea equipment that are to be inspected while the subsea equipment is located in a topside environment; and
determine, based at least in part on the image of the subsea equipment that is located in a topside environment, the representation of the subsea equipment that is located in a topside environment.

5. The apparatus of claim 4, wherein the processor is further to:
receive a request from a user to modify a characteristic of the representation of the subsea equipment that is located in a topside environment; and
determine a second representation of the subsea equipment that is located in a topside environment base at least in part on the request from a user to modify a characteristic of the representation; and
wherein the display is further to display a second view that includes: (i) the second representation of the subsea equipment that is located in a topside environment and (ii) an indicator that indicates a portion of the second representation that includes a representation of one or more portions of the subsea equipment that are to be inspected while the subsea equipment is located in a topside environment.

6. The apparatus of claim 4, wherein the image sensor is further to generate a second image of subsea equipment that is located in a topside environment;
wherein the processor is further to determine a second representation of the subsea equipment that is located in a topside environment based at least in part on the second image of the subsea equipment that is located in a topside environment; and
wherein the display is further to display a second view that includes: (i) the second representation of the subsea equipment that is located in a topside environment and (ii) an indicator that indicates a portion of the second representation that includes a representation of one or more portions of the subsea equipment that are to be inspected while the subsea equipment is located in a topside environment.

7. The apparatus of claim 4, wherein the processor is further to receive a request from a user for instructions in regard to performing an inspection of one or more of the one or more portions of the subsea equipment that are to be inspected while the subsea equipment is located in a topside environment; and
wherein the display is further to display a second view that includes: (i) a representation of the subsea equipment that is located in a topside environment and (ii) instructions in regard to inspection of one or more of the one or more portions of the subsea equipment that are to be inspected while the subsea equipment is located in a topside environment.

8. The apparatus of claim 4, wherein the processor is further to receive a result of an inspection of one or more of the one or more portions of the subsea equipment that are to be inspected while the subsea equipment is located in a topside environment; and
wherein the display is further to display a second view that includes: (i) a representation of the subsea equipment that is located in a topside environment and (ii) an indicator that indicates the result of the inspection of one or more of the one or more portions of the subsea equipment that are to be inspected while the subsea equipment is located in a topside environment.

9. A method comprising:
generating, by an image sensor of a mobile device, an image of subsea equipment that is located in a topside environment; and
displaying, by a display of a mobile device, a view that includes: (i) a representation of the subsea equipment that is located in a topside environment and (ii) an indicator that indicates a portion of the representation that includes a representation of one or more portions of the subsea equipment that are to be inspected while the subsea equipment is located in a topside environment.

10. The method of claim 9, further comprising:
determining, by a processor, based at least in part on the image of the subsea equipment that is located in a topside environment, one or more of the one or more portions of the subsea equipment that are to be inspected while the subsea equipment is located in a topside environment; and
determining, by a processor, based at least in part on the image of the subsea equipment that is located in a topside environment, the representation of the subsea equipment that is located in a topside environment.

11. The method of claim 10, further comprising:
receiving, by a processor, a request from a user to modify a characteristic of the representation of the subsea equipment that is located in a topside environment;
determining, by a processor, a second representation of the subsea equipment that is located in a topside environment base at least in part on the request from a user to modify a characteristic of the representation; and
wherein the display is further to display a second view that includes: (i) the second representation of the subsea equipment that is located in a topside environment and (ii) an indicator that indicates a portion of the second representation that includes a representation of one or more portions of the subsea equipment that are to be inspected while the subsea equipment is located in a topside environment.

12. The method of claim 10, further comprising:
generating, by an image sensor of a mobile device, a second image of subsea equipment that is located in a topside environment; and
determining, by a processor, a second representation of the subsea equipment that is located in a topside environment based at least in part on the second image of the subsea equipment that is located in a topside environment; and
displaying by a display of a mobile device, a second view that includes: (i) the second representation of the subsea equipment that is located in a topside environment and (ii) an indicator that indicates a portion of the second representation that includes a representation of one or more portions of the subsea equipment that are to be inspected while the subsea equipment is located in a topside environment.

13. The method of claim 10, further comprising:
receiving, by a processor, a request from a user for instructions in regard to performing an inspection of one or more of the one or more portions of the subsea equipment that are to be inspected while the subsea equipment is located in a topside environment; and
displaying by a display of a mobile device, a second view that includes: (i) a representation of the subsea equipment that is located in a topside environment and (ii) instructions in regard to inspection of one or more of the one or more portions of the subsea equipment that are to be inspected while the subsea equipment is located in a topside environment.

14. The method of claim 10, further comprising:
receiving, by a processor, a result of an inspection of one or more of the one or more portions of the subsea equipment that are to be inspected while the subsea equipment is located in a topside environment; and
displaying by a display of a mobile device, a second view that includes: (i) a representation of the subsea equipment that is located in a topside environment and (ii) an indicator that indicates the result of the inspection of one or more of the one or more portions of the subsea equipment that are to be inspected while the subsea equipment is located in a topside environment.

15. A non-transitory computer readable storage medium having code stored thereon, the code being executable by a processor to result in a method comprising:
generating, by an image sensor of a mobile device, an image of subsea equipment that is located in a topside environment; and
displaying, by a display of a mobile device, a view that includes: (i) a representation of the subsea equipment that is located in a topside environment and (ii) an indicator that indicates a portion of the representation that includes a representation of one or more portions of the subsea equipment that are to be inspected while the subsea equipment is located in a topside environment.

16. The non-transitory computer readable storage medium of claim 15, the method further comprising:
determining based at least in part on the image of the subsea equipment that is located in a topside environment, one or more of the one or more portions of the subsea equipment that are to be inspected while the subsea equipment is located in a topside environment; and
determining based at least in part on the image of the subsea equipment that is located in a topside environment, the representation of the subsea equipment that is located in a topside environment.

17. The non-transitory computer readable storage medium of claim 16, the method further comprising:
receiving, by a processor, a request from a user to modify a characteristic of the representation of the subsea equipment that is located in a topside environment;
determining, by a processor, a second representation of the subsea equipment that is located in a topside environment base at least in part on the request from a user to modify a characteristic of the representation; and
wherein the display is further to display a second view that includes: (i) the second representation of the subsea equipment that is located in a topside environment and (ii) an indicator that indicates a portion of the second representation that includes a representation of one or more portions of the subsea equipment that are to be inspected while the subsea equipment is located in a topside environment.

18. The non-transitory computer readable storage medium of claim 16, the method further comprising:
generating, by an image sensor of a mobile device, a second image of subsea equipment that is located in a topside environment; and
determining, by a processor, a second representation of the subsea equipment that is located in a topside environment based at least in part on the second image of the subsea equipment that is located in a topside environment; and
displaying by a display of a mobile device, a second view that includes: (i) the second representation of the subsea equipment that is located in a topside environment and (ii) an indicator that indicates a portion of the second representation that includes a representation of one or more portions of the subsea equipment that are to be inspected while the subsea equipment is located in a topside environment.

19. The non-transitory computer readable storage medium of claim 16, the method further comprising:
receiving, by a processor, a request from a user for instructions in regard to performing an inspection of one or more of the one or more portions of the subsea equipment that are to be inspected while the subsea equipment is located in a topside environment; and
displaying by a display of a mobile device, a second view that includes: (i) a representation of the subsea equipment that is located in a topside environment and (ii) instructions in regard to inspection of one or more of the one or more portions of the subsea equipment that are to be inspected while the subsea equipment is located in a topside environment.

20. The non-transitory computer readable storage medium of claim 16, the method further comprising:
receiving, by a processor, a result of an inspection of one or more of the one or more portions of the subsea equipment that are to be inspected while the subsea equipment is located in a topside environment; and
displaying by a display of a mobile device, a second view that includes: (i) a representation of the subsea equipment that is located in a topside environment and (ii) an indicator that indicates the result of the inspection of one or more of the one or more portions of the subsea equipment that are to be inspected while the subsea equipment is located in a topside environment.

21. Apparatus comprising:
a mobile device having an image sensor to generate an image of subsea equipment that is located in a topside environment;
at least one processor to determine, based at least in part on the image of the subsea equipment that is located in a topside environment, one or more portions of the subsea equipment that are to be inspected while the subsea equipment is located in a topside environment; and
a mobile device having a display to display a view that includes: (i) a representation of the subsea equipment that is located in a topside environment and (ii) an indicator that indicates a portion of the representation that includes a representation of one or more of the one or more portions of the subsea equipment that are to be inspected while the subsea equipment is located in a topside environment.

22. A mobile device comprising:
an image sensor to generate an image of subsea equipment that is located in a topside environment;
at least one processor to determine, based at least in part on the image of the subsea equipment that is located in a topside environment, one or more portions of the subsea equipment that are to be inspected while the subsea equipment is located in a topside environment;
a memory, coupled to the processor and storing code executable by the processor; and
a display to display a view that includes: (i) a representation of the subsea equipment that is located in a topside environment and (ii) an indicator that indicates a portion of the representation that includes a representation of one or more of the one or more portions of the subsea equipment that are to be inspected while the subsea equipment is located in a topside environment.
